(19) United States
(12) Patent Application Publication
(10) Pub. No.: US 2006/0166023 A1
(43) Pub. Date: Jul. 27, 2006

(54) Backside protective sheet for solar battery module and solar battery module using the same

(75) Inventors: Kuniaki Yoshikata, Tokyo-To (JP); Atsuo Tsuzuki, Tokyo-To (JP); Koujiro Ohkawa, Tokyo-To (JP); Takaki Miyachi, Tokyo-To (JP)

Correspondence Address: HARNESS, DICKEY & PIERCE, P.L.C., P.O. BOX 828, BLOOMFIELD HILLS, MI, 48303, US

(73) Assignee: DAI NIPPON PRINTING CO., LTD., Tokyo-To (JP)

(21) Appl. No.: 10/526,582

(22) PCT Filed: Feb. 28, 2003
(86) PCT No.: PCT/JP03/02382

§ 371 Date: Mar. 4, 2005

(30) Foreign Application Priority Data
Sep. 6, 2002 (JP) 2002-261187

(51) Int. Cl. B32B 27/32; B32B 19/00

(52) U.S. Cl. 428/523; 428/702

(57) ABSTRACT

There is provided a backside protective sheet for a solar battery module that is excellent in strength as well as in various properties such as weathering resistance, heat resistance, water resistance, light resistance, wind pressure resistance, hailstorm resistance, chemical resistance, moisture resistance, antifouling properties, light reflectivity, light diffusivity, and design, and is particularly excellent in the so-called “moisture resistance,” which is the ability to prevent the entry of moisture, oxygen and the like, and durability against performance degradation with time, particularly against hydrolytic degradation and the like, and is also excellent in protective capability. There is also provided a backside protective sheet for a solar battery module, which can facilitate inventory control by properly using the front side and back side of the protective sheet depending upon applications and is excellent in cost performance, and a solar battery module using the same. The backside protective sheet for a solar battery module comprises: a deposited assembly comprising a vapor-deposited film of an inorganic oxide provided on at least one side of a substrate; and a transparent or translucent heat-resistant polyolefin resin layer provided on both sides of the deposited assembly.

### TECHNICAL FIELD

The present invention relates to a backside protective sheet for a solar battery module and a solar battery module using the same. More particularly, the present invention relates to a backside protective sheet for a solar battery module that is excellent in strength as well as in various properties such as weathering resistance, heat resistance, water resistance, light resistance, wind pressure resistance, hailstorm resistance, chemical resistance, moisture resistance, antifouling properties, light reflectivity, light diffusivity, and design, and is particularly excellent in the so-called “moisture resistance,” which is the ability to prevent the entry of moisture, oxygen and the like, and durability against performance degradation with time, particularly against hydrolytic degradation and the like, and is also excellent in protective capability, and a backside protective sheet for a solar battery module, which can facilitate inventory control, is excellent in cost performance, and is safe, and a solar battery module using the same.

### BACKGROUND ART

A rise in awareness of environmental problems in recent years has led to attractive attention of solar batteries as clean energy sources, and, at the present time, various forms of solar battery modules have been developed and proposed.

The solar battery module is generally prepared, for example, by providing a solar battery element, such as a crystalline silicon solar battery element or an amorphous silicon solar battery element, stacking a surface protective sheet layer, a filler layer, the solar battery element as a photovoltaic element, a filler layer, and a backside protective sheet layer and the like on top of each other in that order to prepare a laminate, and heat-pressing the laminate under vacuum suction by a lamination method.

Solar battery modules were initially applied to pocket calculators and subsequently were applied to various electronic apparatuses and the like. The field of civil application of solar battery modules has rapidly become more and more spread. Realization of a large-scale concentrated solar battery power generation is an important future task.

At the present time, a high-strength plastic substrate or a composite film composed of a fluororesin film and a metal foil is most commonly used as the backside protective sheet layer for a solar battery module constituting the solar battery module. Metal sheets and the like have also been used as the protective sheet layer.

In general, the backside protective sheet layer for a solar battery module constituting the solar battery module should be excellent in strength as well as in various fastness properties such as weathering resistance, heat resistance, water resistance, light resistance, wind pressure resistance, hailstorm resistance, chemical resistance, light reflectivity, light diffusivity, and design, should be particularly excellent in moisture resistance, which is the ability to prevent the entry of moisture, oxygen and the like, further should have high surface hardness and should be excellent in antifouling properties, which are the ability to prevent surface contamination and accumulation of refuse and the like, and should be highly durable, that is, should be excellent in protective capability.

When the currently most commonly used high-strength plastic substrate or the like is used as the backside protective sheet layer, however, this material is excellent in plasticity, lightweightness, processability, workability, cost and the like, but on the other hand, is disadvantageously poor in various fastness properties such as strength, weathering resistance, heat resistance, water resistance, light resistance, chemical resistance, light reflection, light diffusion, and impact resistance, and particularly lacks in moisture resistance, antifouling properties, design and the like.

The use, as the protective sheet layer, of the composite film composed of the fluororesin film and the metal foil is advantageous in that environmental resistance, moisture resistance, workability, light resistance and the like are excellent. This material, however, is poor in various properties such as hydrolysis resistance, flexibility, and lightweightness. In particular, this material as a packaging material for electronic devices in which a relatively high voltage load is expected has a serious problem of lack in short-circuiting resistance as a required main property. This is because, since a metal foil is used, internal short-circuiting possibly takes place upon exposure to impact such as denting, resulting in superheating.

Further, in the case of the fluororesin film, some disposal methods have a fear of burdening on environment. Therefore, it is difficult to say that the fluororesin film is best suited as a member of a solar battery system which calls for clean energy. This material is also disadvantageously high in cost.

Furthermore, in the case of a metal plate, this material is excellent in strength and in various fastness properties such as weathering resistance, heat resistance, water resistance, light resistance, chemical resistance, piercing resistance, and impact resistance, is excellent in moisture resistance, has high surface hardness, is excellent in antifouling properties, which are the ability to prevent surface contamination and accumulation of refuse and the like, that is, can be said to have very high protective capability. This material, however, lacks in plasticity, lightweightness, light reflection, light diffusion, design and the like, is poor in forming properties and workability, and is disadvantageously high in cost.

In order to solve the above problem, the present inventor has previously proposed a backside protective sheet for a solar battery module characterized in that a vapor-deposited film of an inorganic oxide is provided on one side of a substrate film to prepare a deposited assembly and a heat resistant polypropylene resin film containing a whitening agent and an ultraviolet absorber is stacked on both sides of the deposited assembly, that is, the substrate with a deposited film of an inorganic oxide formed thereon (see Japanese Patent Laid-Open No. 111077/2001).

The backside protective sheet for a solar battery module proposed above and the solar battery module using the same satisfy the requirements for the above-described various properties accordingly. However, there is still room for improvement. In particular, resistance to moist heat such as a deterioration caused by hydrolysis through the action of moisture and the like is not yet satisfactory.

Further, when application to a building field where importance is attached to design is taken into consideration, a solar battery module having a color which is matched with existing buildings is required. Therefore, the color of the backside protective sheet for a solar battery module should be adjusted according to the color of each building. A number of types should be provided depending upon applications. This poses problems of inventory control and cost.

Accordingly, an object of the present invention is to provide a backside protective sheet for a solar battery module that is excellent in strength as well as in various properties such as weathering resistance, heat resistance, water resistance, light resistance, wind pressure resistance, hailstorm resistance, chemical resistance, moisture resistance, antifouling properties, light reflectivity, light diffusivity, and design, and is particularly excellent in the so-called “moisture resistance,” which is the ability to prevent the entry of moisture, oxygen and the like, and durability against performance degradation with time, particularly against hydrolytic degradation and the like, and is also excellent in protective capability, a backside protective sheet for a solar battery module, which can facilitate inventory control by properly using the front side and back side of the protective sheet depending upon applications and is excellent in cost performance, and a solar battery module using the same.

### DISCLOSURE OF THE INVENTION

The present inventor has made extensive and intensive studies on a backside protective sheet layer constituting a solar battery module with a view to solving the above problems of the prior art, which has led to the completion of the present invention.

According to one aspect of the present invention, there is provided a backside protective sheet for a solar battery module, comprising: a deposited assembly comprising a vapor-deposited film of an inorganic oxide provided on at least one side of a substrate; and a transparent or translucent heat-resistant polyolefin resin layer provided on both sides of said deposited assembly.

According to another aspect of the present invention, there is provided a backside protective sheet for a solar battery module, comprising: a superimposed laminate comprising a plurality of deposited assemblies superimposed on top of each other, said plurality of deposited assemblies each comprising a vapor-deposited film of an inorganic oxide provided on at least one side of a substrate; and a transparent or translucent heat-resistant polyolefin resin layer provided on both sides of said superimposed laminate. Preferably, the superimposed laminate comprises said deposited assemblies superimposed on top of each other through a tough resin film.

Preferably, at least one of the polyolefin resin layers provided on the deposited assembly or both sides of the superimposed laminate comprises a coloring additive.

Preferably, the coloring additive contained in one of the polyolefin resin layer is different from said coloring additive contained in the other polyolefin resin layer in color.

According to still another aspect of the present invention, there is provided a backside protective sheet for a solar battery module, comprising: a deposited assembly comprising a vapor-deposited film of an inorganic oxide provided on at least one side of a substrate; a heat-resistant polyolefin resin layer comprising a coloring additive and provided on one side of said deposited assembly; and a heat sealing resin layer provided on the other side of said deposited assembly.

According to a further aspect of the present invention, there is provided a backside protective sheet for a solar battery module, comprising: a superimposed laminate comprising a plurality of deposited assemblies superimposed on top of each other, said plurality of deposited assemblies each comprising a vapor-deposited film of an inorganic oxide provided on at least one side of a substrate; a heat-resistant polyolefin resin layer comprising a coloring additive and provided on one side of said superimposed laminate; and a heat sealing resin layer provided on the other side of said superimposed laminate. In this superimposed laminate, preferably, the deposited assembly is laminated through a tough resin film.

Preferably, the polyolefin resin layer comprises an ultraviolet absorber and a photostabilizer. In particular, preferably, at least one of the polyolefin resin layers provided respectively on said both sides of the laminated film comprises a coloring additive.

The backside protective sheets for a solar battery module having the above constructions are excellent in strength as well as in various properties such as weathering resistance, heat resistance, water resistance, light resistance, wind pressure resistance, hailstorm resistance, chemical resistance, moisture resistance, antifouling properties, light reflectivity, light diffusivity, and design, and are particularly excellent in the so-called “moisture resistance,” which is the ability to prevent the entry of moisture, oxygen and the like, and durability against performance degradation with time, particularly against hydrolytic degradation and the like, and are also excellent in protective capability.

The provision of the transparent or translucent polyolefin resin layer can realize the application of the backside protective sheet for a solar battery module to solar battery modules for use in roofs, windows, wall surfaces and the like where daylighting is required, and solar battery modules where the entry of light from the backside is required.

Further, when the color of the coloring agent added to the polyolefin resin layer on one side is different from the color of the coloring agent added to the polyolefin resin layer on the other side, the backside protective sheet has both the advantage of color specifications on one side and the advantage of color specifications of the other side. Therefore, this construction can cope with two specifications in one type, and the front side and back side can be used properly depending upon applications. Thus, the backside protective sheet for a solar battery module is easy in inventory management and has excellent cost performance.

### BRIEF DESCRIPTION OF THE DRAWINGS

FIG. 1 is a schematic cross-sectional view of an embodiment of the layer construction of the backside protective sheet for a solar battery module according to a first aspect of the present invention;

FIG. 2 is a schematic cross-sectional view of an embodiment of the layer construction of the backside protective sheet for a solar battery module according to a first aspect of the present invention;

FIG. 3 is a schematic cross-sectional view of an embodiment of the layer construction of the backside protective sheet for a solar battery module according to a first aspect of the present invention;

FIG. 4 is a schematic cross-sectional view of an embodiment of the layer construction of the backside protective sheet for a solar battery module according to a first aspect of the present invention;

FIG. 5 is a schematic cross-sectional view of an embodiment of the layer construction of the backside protective sheet for a solar battery module according to a first aspect of the present invention;

FIG. 6 is a schematic cross-sectional view of an embodiment of the layer construction of the backside protective sheet for a solar battery module according to a second aspect of the present invention;

FIG. 7 is a schematic cross-sectional view of an embodiment of the layer construction of the backside protective sheet for a solar battery module according to a second aspect of the present invention;

FIG. 8 is a schematic cross-sectional view of an embodiment of the layer construction of the backside protective sheet for a solar battery module according to a second aspect of the present invention;

FIG. 9 is a schematic cross-sectional view of an embodiment of the layer construction of the backside protective sheet for a solar battery module according to a second aspect of the present invention;

FIG. 10 is a schematic cross-sectional view of an embodiment of the layer construction of the backside protective sheet for a solar battery module according to a second aspect of the present invention;

FIG. 11 is a schematic cross-sectional view of an embodiment of the layer construction of the backside protective sheet for a solar battery module according to a third aspect of the present invention;

FIG. 12 is a schematic cross-sectional view of an embodiment of the layer construction of the backside protective sheet for a solar battery module according to a third aspect of the present invention;

FIG. 13 is a schematic cross-sectional view of an embodiment of the layer construction of the backside protective sheet for a solar battery module according to a third aspect of the present invention;

FIG. 14 is a schematic cross-sectional view of an embodiment of the layer construction of the backside protective sheet for a solar battery module according to a third aspect of the present invention;

FIG. 15 is a schematic cross-sectional view of an embodiment of the layer construction of the backside protective sheet for a solar battery module according to a third aspect of the present invention;

FIG. 16 is a schematic cross-sectional view of an embodiment of the layer construction of the backside protective sheet for a solar battery module according to a fourth aspect of the present invention;

FIG. 17 is a schematic cross-sectional view of an embodiment of the layer construction of the backside protective sheet for a solar battery module according to a fourth aspect of the present invention;

FIG. 18 is a schematic cross-sectional view of an embodiment of the layer construction of the backside protective sheet for a solar battery module according to a fourth aspect of the present invention;

FIG. 19 is a schematic cross-sectional view showing another embodiment of the layer construction of a vapor-deposited film of an inorganic oxide;

FIG. 20 is a schematic cross-sectional view showing still another embodiment of the layer construction of a vapor-deposited film of an inorganic oxide;

FIG. 21 is a schematic cross-sectional view of an embodiment of the layer construction of a solar battery module produced using the backside protective sheet for a solar battery module according to the present invention shown in FIG. 1;

FIG. 22 is a schematic cross-sectional view of an embodiment of the layer construction of a solar battery module produced using the backside protective sheet for a solar battery module according to the present invention shown in FIG. 16;

FIG. 23 is a schematic block diagram showing an embodiment of a winding-type vacuum vapor deposition apparatus; and

FIG. 24 is a schematic block diagram showing an embodiment of a plasma chemical vapor deposition apparatus.

### BEST MODE FOR CARRYING OUT THE INVENTION

The present invention will be described in more detail with reference to the accompanying drawings and the like.

The term “sheet” as used herein means both a sheet-shaped material and a film-shaped material, and the term “film” as used herein means both a film-shaped material and a sheet-shaped material.

The backside protective sheet for a solar battery module according to the present invention and the solar battery module using the same will be described in more detail with reference to the accompanying drawings and the like.

Backside Protective Sheet for Solar Battery Module According to First Aspect of Invention

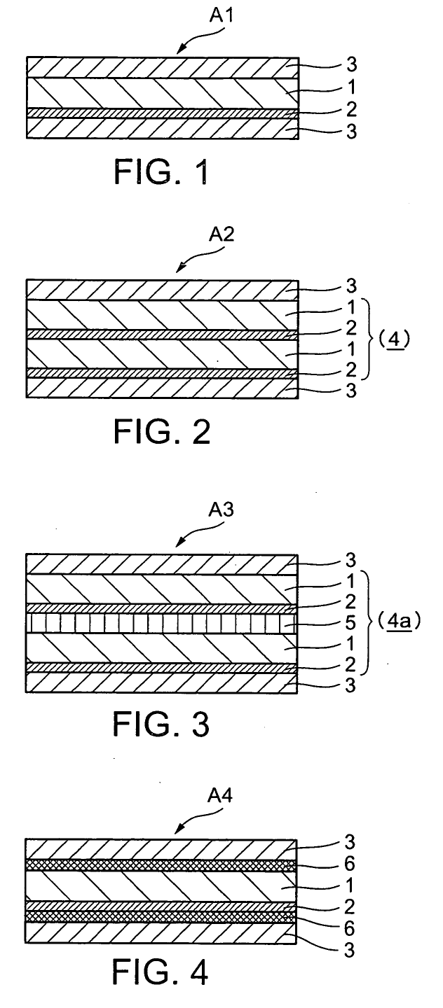

FIGS. 1 to 5 are schematic cross-sectional views showing embodiments of the layer construction of the backside protective sheet for a solar battery module according to the first aspect of the present invention.

As shown in FIG. 1, a backside protective sheet A1 for a solar battery module according to the present invention includes a vapor-deposited film 2 of an inorganic oxide provided on one side of a substrate film 1. A heat resistant polyolefin resin film 3 containing a coloring additive, an ultraviolet absorber, and a photostabilizer is laminated onto both sides of the substrate film 1 with the vapor-deposited film 2 of an inorganic oxide provided thereon, that is, onto the substrate film in its side remote from the vapor-deposited film and onto the vapor-deposited film.

As shown in FIG. 2, the backside protective sheet A2 for a solar battery module according to the present invention includes a vapor-deposited film 2 of an inorganic oxide provided on one side of a substrate film 1 to constitute a deposited assembly. Two or more deposited assemblies are superimposed on top of each other to provide a superimposed laminate 4, and a heat resistant polyolefin resin film 3 containing a coloring additive, an ultraviolet absorber, and a photostabilizer is laminated onto both sides of the superimposed laminate 4.

As shown in FIG. 3, the backside protective sheet A3 for a solar battery module according to the present invention includes a vapor-deposited film 2 of an inorganic oxide provided on one side of a substrate film 1 to constitute a deposited assembly. Two or more deposited assemblies are superimposed on top of each other through a tough resin film 5 to provide a superimposed laminate 4a, and a heat resistant polyolefin resin film 3 containing a coloring additive, an ultraviolet absorber, and a photostabilizer is laminated onto both sides of the superimposed laminate 4a.

The above backside protective sheets for a solar battery module are embodiments of the backside protective sheets for a solar battery module according to the present invention. The present invention, however, is not limited to these embodiments.

In the above lamination, the surface of the vapor-deposited film of an inorganic oxide may be subjected to pretreatment such as plasma treatment or corona treatment, or alternatively a primer layer, a desired resin layer or the like may be provided according to need from the viewpoint of improving adhesion in the lamination.

A method for laminating the polyolefin resin film will be described by taking the backside protective sheet A1 for a solar battery module shown in FIG. 1 as an example.

As shown in FIG. 4, a backside protective sheet A4 for a solar battery module may be produced by a dry lamination method which comprises providing the vapor-deposited film 2 of an inorganic oxide on one side of the substrate film 1 to provide a deposited assembly and dry-laminating the heat resistant polyolefin resin film 3 containing a coloring additive, an ultraviolet absorber, and a photostabilizer onto both sides of the deposited assembly, that is, onto the vapor-deposited film 2 of an inorganic oxide and onto the substrate film 1 in its side remote from the vapor-deposited film 2, through a laminating adhesive layer 6.

The backside protective sheets for a solar battery module according to the present invention shown in FIGS. 2 and 3 can also be produced by the dry lamination method in which lamination is carried out through the laminating adhesive layer (not shown).

Another method for laminating the polyolefin resin film will be described by taking the backside protective sheet A1 for a solar battery module shown in FIG. 1 as an example.

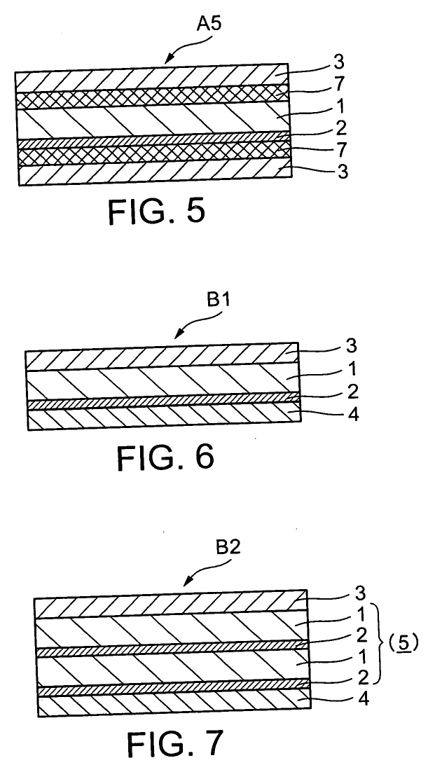

As shown in FIG. 5, a backside protective sheet A5 for a solar battery module may be produced by a method which comprises providing the vapor-deposited film 2 of an inorganic oxide on one side of the substrate film 1 to provide a deposited assembly and laminating the heat resistant polyolefin resin film 3 containing a coloring additive, an ultraviolet absorber, and a photostabilizer onto both sides of the deposited assembly, that is, onto the vapor-deposited film 2 and onto the substrate film 1 in its side remote from the vapor-deposited film 2, through, for example, a bonding assistant layer of an anchor coating agent or the like or a melt extruded resin layer 7 by a melt extrusion lamination method.

The backside protective sheets for a solar battery module shown in FIGS. 2 and 3 can also be produced by the melt extrusion lamination method in which lamination is carried out by melt extrusion, for example, through the bonding assistant layer of an anchor coating agent or the like or a melt extruded resin layer (not shown).

Alternatively, the polyolefin resin layer may be formed by coating or printing the heat resistant polyolefin resin composition containing a coloring additive, an ultraviolet absorber, and a photostabilizer, for example, by a conventional coating or printing method.

Further, in the present invention, a combination of the dry lamination method with the melt extrusion lamination method may be used to prepare the backside protective sheet for a solar battery module (not shown).

In the superimposition of two or more deposited assemblies each comprising a vapor-deposited film of an inorganic oxide provided on a substrate film, any side of one of the deposited assemblies may face any side of another deposited assembly. For example, the surface of the vapor-deposited film of an inorganic oxide in one of the deposited assemblies may face the surface of the substrate film in another deposited assembly, or the surface of the substrate film in one of the deposited assemblies may face the surface of the substrate film in another deposited assembly, or the surface of the vapor-deposited film of an inorganic oxide in one of the deposited assemblies may face the surface of the vapor-deposited film of an inorganic oxide in another deposited assembly (not shown). In this case, any of the above lamination methods, for example, the dry lamination method in which lamination is carried out through a laminating adhesive layer, and the melt extrusion lamination method in which lamination is carried out through a bonding assistant layer of an anchor coating agent or the like or a melt extrusion resin layer, may be used for the superimposition of the deposited assemblies.

In the present invention, for example, a combination of the dry lamination method with the melt extrusion lamination method may be used to prepare the backside protective sheet for a solar battery module (not shown).

In the superimposition of two or more deposited assemblies each comprising a vapor-deposited film of an inorganic oxide provided on a substrate film through a tough resin film, as with the above embodiment, any of the above lamination methods, for example, the dry lamination method in which lamination is carried out through a laminating adhesive layer, and the melt extrusion lamination method in which lamination is carried out through a bonding assistant layer of an anchor coating agent or the like or a melt extrusion resin layer, may be used for the superimposition of the deposited assemblies. Further, the superimposition may be carried out so that, for example, any of the surface of the vapor-deposited film of an inorganic oxide, the surface of the substrate film, and the surface of the tough resin film on one deposited assembly side faces the other deposited assembly.

In the present invention, a combination of the dry lamination method with the melt extrusion lamination method may be used to prepare the backside protective sheet for a solar battery module (not shown).

Backside Protective Sheet for Solar Battery Module According to Second Aspect of Invention

FIGS. 6 to 10 are schematic cross-sectional views showing embodiments of the layer construction of the backside protective sheet for a solar battery module according to the second aspect of the present invention.

As shown in FIG. 6, a backside protective sheet B1 for a solar battery module according to the second aspect of the present invention includes a vapor-deposited film 2 of an inorganic oxide provided on one side of a substrate film 1 to provide a deposited assembly. A heat resistant polyolefin resin film 3 containing a coloring additive, an ultraviolet absorber, and a photostabilizer is laminated onto one side of the deposited assembly, that is, the substrate film 1 with the vapor-deposited film 2 of an inorganic oxide provided thereon. A heat resistant polyolefin resin film 4 containing a coloring additive, which is different from the above coloring additive in hue, an ultraviolet absorber, and a photostabilizer, is laminated onto the other side of the deposited assembly.

As shown in FIG. 7, a backside protective sheet B2 for a solar battery module according to the present invention includes a vapor-deposited film 2 of an inorganic oxide provided on one side of a substrate film 1 to provide a deposited assembly. Two or more deposited assemblies, that is, two or more substrate films 1 each with the vapor-deposited film 2 of an inorganic oxide provided thereon, are superimposed on top of each other to provide a superimposed laminate 5. A heat resistant polyolefin resin film 3 containing a coloring additive, an ultraviolet absorber, and a photostabilizer is laminated onto one side of the superimposed laminate 5. A heat resistant polyolefin resin film 4 containing a coloring additive, which is different from the above coloring additive in hue, an ultraviolet absorber, and a photostabilizer, is laminated onto the other side of the superimposed laminate 5.

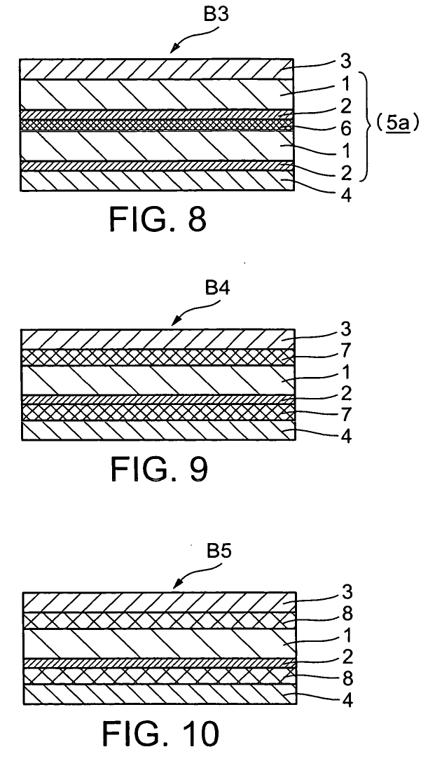

As shown in FIG. 8, a backside protective sheet B3 for a solar battery module according to the present invention includes a vapor-deposited film 2 of an inorganic oxide provided on one side of a substrate film 1 to provide a deposited assembly. Two or more deposited assemblies, that is, two or more substrate films 1 each with the vapor-deposited film 2 of an inorganic oxide provided thereon, are superimposed on top of each other through a tough resin film 6 to provide a superimposed laminate 5a. A heat resistant polyolefin resin film 3 containing a coloring additive, an ultraviolet absorber, and a photostabilizer is laminated onto one side of the superimposed laminate 5a. A heat resistant polyolefin resin film 4 containing a coloring additive, which is different from the above coloring additive in hue, an ultraviolet absorber, and a photostabilizer, is laminated onto the other side of the superimposed laminate 5.

As shown in FIGS. 9 and 10, the method for laminating the polyolefin resin film, the method for superimposing the deposited assemblies, and the method for superimposing the deposited assemblies through a tough resin film may of course be the same as those described above in connection with the backside protective sheet for a solar battery module according to the first aspect of the present invention.

Backside Protective Sheet for Solar Battery Module According to Third Aspect of Invention

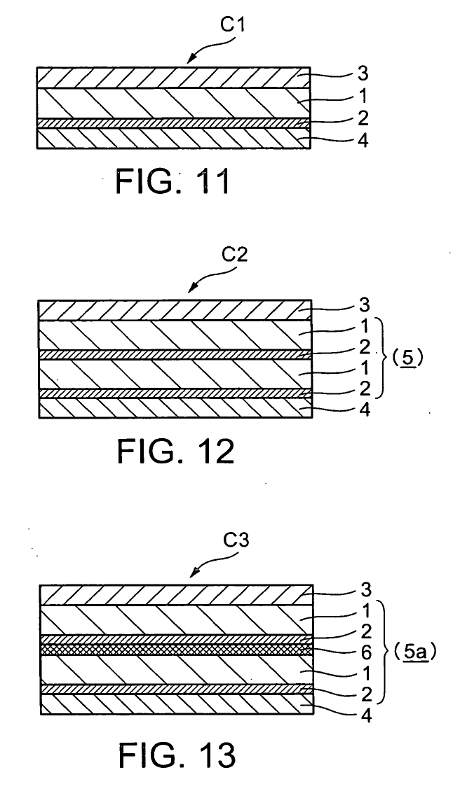

FIGS. 11 to 15 are schematic cross-sectional views showing embodiments of the layer construction of the backside protective sheet for a solar battery module according to the third aspect of the present invention.

As shown in FIG. 11, a backside protective sheet C1 for a solar battery module according to the third aspect of the present invention includes a vapor-deposited film 2 of an inorganic oxide provided on one side of a substrate film 1 to provide a deposited assembly. A heat resistant colored polyolefin resin film 3 containing a coloring additive, an ultraviolet absorber, and a photostabilizer or a heat resistant transparent/translucent polyolefin resin film 3 containing an ultraviolet absorber and a photostabilizer is laminated onto one side of the deposited assembly, that is, the substrate film 1 with the vapor-deposited film 2 of an inorganic oxide provided thereon. A heat resistant transparent/translucent polyolefin resin film 4 containing an ultraviolet absorber and a photostabilizer is laminated onto the other side of the deposited assembly.

As shown in FIG. 12, a backside protective sheet C2 for a solar battery module according to the present invention includes a vapor-deposited film 2 of an inorganic oxide provided on one side of a substrate film 1 to provide a deposited assembly. Two or more deposited assemblies, that is, two or more substrate films 1 each with the vapor-deposited film 2 of an inorganic oxide formed thereon, are superimposed on top of each other to provide a superimposed laminate 5. A heat resistant colored polyolefin resin film 3 containing a coloring additive, an ultraviolet absorber, and a photostabilizer or a heat resistant transparent/translucent polyolefin resin film 3 containing an ultraviolet absorber and a photostabilizer is laminated onto one side of the superimposed laminate 5. A heat resistant transparent/translucent polyolefin resin film 4 containing an ultraviolet absorber and a photostabilizer is laminated onto the other side of the superimposed laminate 5.

As shown in FIG. 13, a backside protective sheet C3 for a solar battery module according to the present invention includes a vapor-deposited film 2 of an inorganic oxide provided on one side of a substrate film 1 to provide a deposited assembly. Two or more deposited assemblies, that is, two or more substrate films 1 each with the vapor-deposited film 2 of an inorganic oxide formed thereon, are superimposed on top of each other through a tough resin film 6 to provide a superimposed laminate 5a. A heat resistant colored polyolefin resin film 3 containing a coloring additive, an ultraviolet absorber, and a photostabilizer or a heat resistant transparent/translucent polyolefin resin film 3 containing an ultraviolet absorber and a photostabilizer is laminated onto one side of the superimposed laminate 5a. A heat resistant transparent/translucent polyolefin resin film 4 containing an ultraviolet absorber and a photostabilizer is laminated onto the other side of the superimposed laminate 5a.

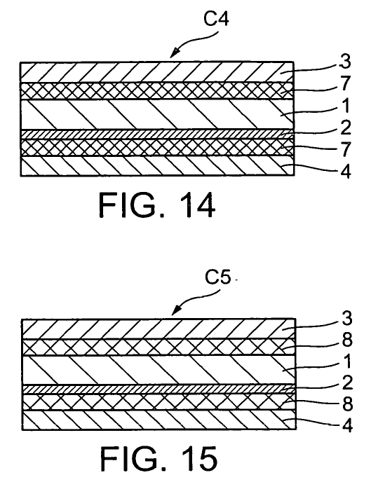

As shown in FIGS. 14 and 15, the method for laminating the polyolefin resin film, the method for superimposing the deposited assemblies, and the method for superimposing the deposited assemblies through a tough resin film may of course be the same as those described above in connection with the backside protective sheets for a solar battery module according to the first and second aspects of the present invention.

Backside Protective Sheet for Solar Battery Module According to Fourth Aspect of Invention

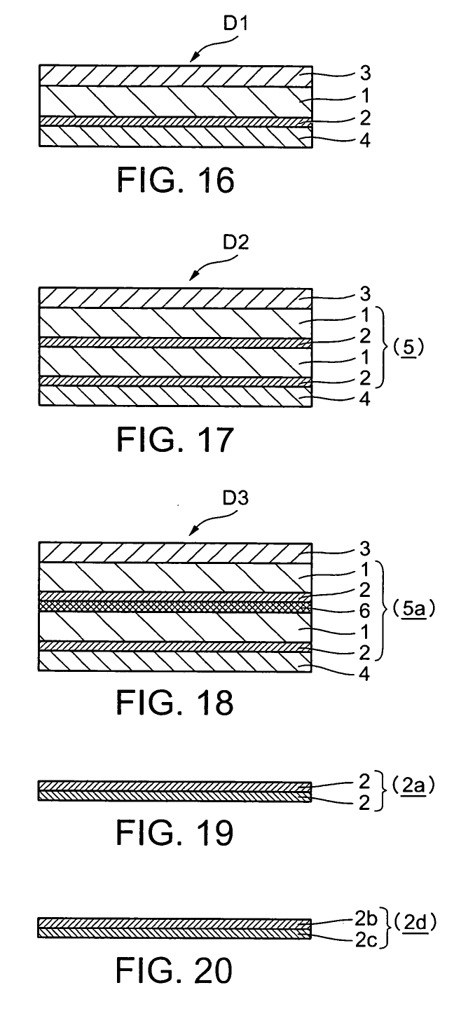

FIGS. 16 to 18 are schematic cross-sectional views showing embodiments of the layer construction of the backside protective sheet for a solar battery module according to the present invention.

As shown in FIG. 16, a backside protective sheet D1 for a solar battery module according to the present invention includes a vapor-deposited film 2 of an inorganic oxide provided on one side of a substrate film 1 to constitute a deposited assembly. A heat resistant polypropylene resin film 3 containing a coloring additive, an ultraviolet absorber, and a photostabilizer is laminated onto one side of the deposited assembly, that is, onto the substrate film 1 in its side remote from the vapor-deposited film 2 of an inorganic oxide or onto the vapor-deposited film 2. A heat seal resin layer 4 is laminated onto the other side of the deposited assembly.

As shown in FIG. 17, the backside protective sheet D2 for a solar battery module according to the present invention includes a vapor-deposited film 2 of an inorganic oxide provided on one side of a substrate film 1 to constitute a deposited assembly. Two or more deposited assemblies are superimposed on top of each other to provide a superimposed laminate 5. A heat resistant polypropylene resin film 3 containing a coloring additive, an ultraviolet absorber, and a photostabilizer is laminated onto one side of the superimposed laminate 5, and a heat sealing resin layer 4 is laminated onto the other side of the superimposed laminate 5.

As shown in FIG. 18, the backside protective sheet D3 for a solar battery module according to the present invention includes a vapor-deposited film 2 of an inorganic oxide provided on one side of a substrate film 1 to constitute a deposited assembly. Two or more deposited assemblies are superimposed on top of each other through a tough resin film 6 to provide a superimposed laminate 5a. A heat resistant polypropylene resin film 3 containing a coloring additive, an ultraviolet absorber, and a photostabilizer is laminated onto one side of the superimposed laminate 5a, and a heat sealing resin layer 4 is laminated onto the other side of the superimposed laminate 5a.

The heat sealing resin layer may be laminated in the same manner as in the lamination of the polypropylene resin film, for example, by a dry lamination method in which a heat sealing resin film is dry laminated through a laminating adhesive layer, or a melt extrusion lamination method in which a heat sealing resin film is laminated by melt extrusion, for example, through a bonding aid layer of an anchor coating agent or the like or a melt extruded resin layer, a melt extrusion lamination method in which a heat seal resin is extrusion-laminated through a bonding aid layer of an anchor coating agent or the like to form a heat seal resin layer, or a coating or printing method in which a heat seal resin composition comprising a vehicle composed mainly of one or more heat sealing resins are coated or printed, for example, by a conventional coating or printing method to form a coated or printed film formed of a heat seal resin film (not shown).

The method for laminating the polyolefin resin film, the method for superimposing the deposited assemblies, and the method for superimposing the deposited assemblies through a tough resin film may of course be the same as those described above in connection with the backside protective sheets for a solar battery module according to the first to third aspects of the present invention.

The above embodiments illustrate the construction of the backside protective sheet for a solar battery module according to the present invention. However, the present invention is of course not limited to these embodiments.

Further, in the backside protective sheets for a solar battery module shown in FIGS. 1 to 18, as shown, for example, in FIGS. 19 and 20, the deposited film of an inorganic oxide may be, for example, a multilayered film 2a (FIG. 19) comprising two or more vapor-deposited films 2 of an inorganic oxide superimposed on top of each other, for example, two or more vapor-deposited films of an inorganic oxide formed by a physical vapor deposition process which will be described later, or two or more vapor-deposited films of an inorganic oxide formed by a chemical vapor deposition process, or may be a composite film 2d (FIG. 20) comprising two or more superimposed layers in total of vapor-deposited films 2b, 2c of dissimilar inorganic oxides, that is, a vapor-deposited film 2b of an inorganic oxide formed by a physical vapor deposition process, which will be described later, and a vapor-deposited film 2c of an inorganic oxide formed by a chemical vapor deposition process.

In producing the backside protective sheet for a solar battery module according to the present invention, for example, when the polyolefin resin film is laminated, or when two or more deposited assemblies, that is, two or more substrate films each with an inorganic oxide deposited film provided thereon are superimposed on top of each other, in order to improve the adhesion to the substrate film, the surface of the vapor-deposited film may be subjected to plasma treatment, corona treatment or other pretreatment, or alternatively a primer layer, a desired resin layer or the like may be optionally provided on the vapor-deposited film.

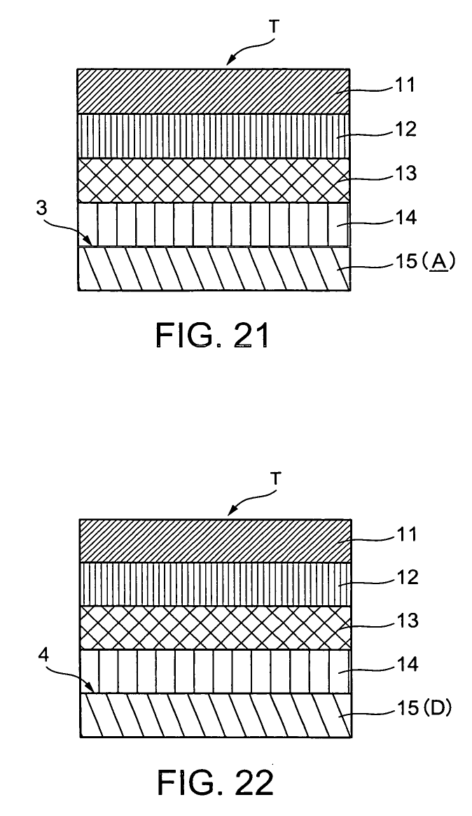

Next, a solar battery module using the backside protective sheet for a solar battery module according to the present invention will be described by taking the backside protective sheet A1 for a solar battery module shown in FIG. 1. As shown in FIG. 21, at the outset, a conventional surface protective sheet 11 for a solar battery module, a filler layer 12, a solar battery element 13 as a photovoltaic element, a filler layer 14, and the backside protective sheet 15(A) for a solar battery module are stacked in that order so that the surface of the polypropylene resin film 3 in the backside protective sheet 15(A) for a solar battery module faces the filler layer 14. Next, the assembly can be subjected to integral molding by a conventional molding method such as a lamination method in which heat pressing is carried out under vacuum suction to produce a solar battery module T.

Further, as shown in FIG. 22, at the outset, a conventional surface protective sheet 11 for a solar battery module, a filler layer 12, a solar battery element 13 as a photovoltaic element, a filler layer 14, and the backside protective sheet 15 (D) for a solar battery module are stacked in the order so that the surface of the heat sealing resin layer 4 faces the filler layer 14. Next, the assembly can be subjected to integral molding by a conventional molding method such as a lamination method in which heat pressing is carried out under vacuum suction to produce a solar battery module T.

The above embodiments of the solar battery module using the backside protective sheet for a solar battery module according to the present invention are illustrative only and are not intended to limit the present invention.

Various forms of the solar battery module can be prepared using the backside protective sheets for a solar battery module shown, for example, in FIGS. 2 to 18 in the same manner as described above. Further, in the solar battery module, other layers may be additionally stacked for sunlight absorption, reinforcement or other purposes (not shown).

Next, in the present invention, for example, materials for constituting the backside protective sheet for a solar battery module according to the present invention, the solar battery module using the backside protective sheet for a solar battery module, production process and the like will be described in more detail.

Substrate films which are preferably used for constituting the backside protective sheet for a solar battery module according to the present invention, the solar battery module and the like include various resin films or sheets that can withstand vapor deposition conditions and the like, for example, in the formation of a vapor-deposited film of an inorganic oxide, are excellent in adhesion to a vapor-deposited film of an inorganic oxide and the like, can satisfactorily retain the properties of the film without sacrificing the properties of the film, and, at the same time, are excellent in strength as well as in various fastness properties such as weathering resistance, heat resistance, water resistance, light resistance, wind pressure resistance, hailstorm resistance, and chemical resistance, and is particularly excellent in moisture resistance which is the ability to prevent the entry of moisture, oxygen and the like, and, in addition, have high surface hardness, are excellent in antifouling properties which prevent accumulation of surface contamination, refuse and the like, are highly durable, and are excellent in protective capability.

Specific examples of resin films or sheets include films or sheets of various resins, for example, polyethylene resins, polypropylene resins, cyclic polyolefin resins, polystyrene resins such as syndiotactic polystyrene resins, acrylonitrile-styrene copolymers (AS resins), acrylonitrile-butadiene-styrene copolymers (ABS resins), polyvinyl chloride resins, fluorocarbon resins, poly(meta)acrylic resins, polycarbonate resins, polyester resins, such as polyethylene terephthalate and polyethylene naphthalate, polyamide resins, such as nylons, polyimide resins, polyamidimide resins, polyaryl phthalate resins, silicone resins, polysulfone resins, polyphenylene sulfide resins, polyether sulfone resins, polyurethane resins, acetal resins, cellulose resins and the like.

In the present invention, among the above resin films or sheets, films or sheets of cyclic polyolefin resins, polycarbonate resins, poly(meth)acrylic resins, polystyrene resins, polyamide resins, and polyester resins are preferred.

When the above resin film or sheet is used, various properties of the resin film or sheet such as excellent mechanical properties, chemical properties, and physical properties, specifically excellent weathering resistance, heat resistance, water resistance, light resistance, moisture resistance, antifouling properties, chemical resistance or other properties can be utilized to provide a backside protective sheet for constituting a solar battery that advantageously has durability, protective capability and the like, are lightweight and have excellent fabricability by virtue of their flexibility, mechanical properties, chemical properties and other properties, and are easy to handle.

In the present invention, for example, the resin film or sheet may be produced by a method in which one or more of the above various resins are used solely for film formation by a film formation method such as an extrusion method, a cast molding method, a T die method, a cutting method, an inflation method, or other film forming methods, or by a method in which two or more resins are used for film formation by multilayer coextrusion, or by a method in which two or more resins are provided and are mixed together before film formation. Further, the resin film or sheet can be formed by uniaxial or biaxial stretching of the resin using, for example, a tenter method or a tubular method.

Thickness of the resin film or sheet is about 9 to 300 μm, preferably 12 to 200 μm.

In this case, in the formation of the resin film or sheet using one or more of the various resins, various plastic compounding agents, additives and the like may be added from the viewpoints of improving and modifying, for example, film forming properties, heat resistance, light resistance, weathering resistance, mechanical properties, dimensional stability, antioxidation properties, slipperiness, releasability, flame retardancy, antifungal properties, electrical properties and the like. The amount of the additives added may range from a very small amount to several tens of percents depending upon the purposes.

Additives usable herein include, for example, lubricants, crosslinking agents, antioxidants, ultraviolet absorbers, photostabilizers, fillers, lubricants, reinforcing fibers, reinforcements, antistatic agents, flame retardants, flame-resistant agents, foaming agents, antifungal agents, and pigments. Further, resins for modification and the like may also be used.

In the present invention, among the above additives, for example, ultraviolet absorbs, photostabilizers, or antioxidants are preferred. The use of a resin film or sheet with the above additives incorporated therein is preferred.

The ultraviolet absorber absorbs harmful ultraviolet rays contained in sunlight, converts the energy of ultraviolet rays into harmless thermal energy in its molecules to prevent active species that starts the photodeterioration of polymers from being excited. Examples thereof include benzophenone, benzotriazole, salicylate, acrylonitrile, metallic complex salt, ultrafine particle titanium oxide (particle size: 0.01 to 0.06 μm) or ultrafine particle zinc oxide (particle size: 0.01 to 0.04 μm) or other inorganic ultraviolet absorbers. One or more of them may be used.

Photostabilzers usable herein include, for example, hindered amine compounds and hindered piperidine compounds. One or more of them may be used.

Antioxidants are those which can prevent a deterioration of polymers by oxidation due to light, heat or the like, and examples thereof include phenolic, amine, sulfur, phosphoric acid or other antioxidants.

The ultraviolet absorber, photostabilizer or antioxidant may also be, for example, a polymer-type ultraviolet absorber, photostabilizer or antioxidant in which an ultraviolet absorber such as the benzophenone ultraviolet absorber, a photostabilizer such as the hindered amine compound, or an antioxidant such as the phenolic antioxidant has been chemically bonded to a main chain or side chain constituting the resin polymer.

The content of the additive is preferably about 0.1 to 10% by weight although it may vary depending upon the shape of particles, density and the like.

In the present invention, if necessary, a desired surface treatment layer may be previously provided on the surface of the resin film or sheet, for example, from the viewpoint of improving adhesion to the vapor-deposited film of an inorganic oxide or the like.

The surface treatment layer may be formed, for example, by any pretreatment such as corona discharge treatment, ozone treatment, plasma treatment using oxygen gas or nitrogen gas, glow discharge treatment, or oxidation treatment using a chemical or the like.

The surface pretreatment may be carried out as a separate step. When the surface treatment is carried out, for example, by plasma treatment or glow discharge treatment, in forming the vapor-deposited film of an inorganic oxide or the like on the substrate film, the pretreatment step may be carried out by inline treatment. The inline treatment can advantageously reduce the production cost.

The above surface pretreatment is carried out for improving the adhesion between the resin film or sheet and the vapor-deposited film of an inorganic oxide or the like. Other methods usable herein include previous formation of any of a primer coating agent layer, an undercoating agent layer, an anchor coating agent layer, an adhesive layer, or a vapor deposition anchor coating agent layer on the surface of the resin film or sheet.

The coating agent for the pretreatment may be, for example, a resin composition comprising a vehicle composed mainly of a polyester resin, a polyamide resin, a polyurethane resin, an epoxy resin, a phenolic resin, an (meta)acrylic resin, a polyvinyl acetate resin, a polyolefin resin such as a polyethylene and a polypropylene or a copolymer or a resin obtained by modifying one of those resins, a cellulose resin or the like.

Epoxy silane coupling agents may be added to the resin composition from the viewpoint of improving the adhesion, and, if necessary, antiblocking agents or other additives may be added to the resin composition from the viewpoint of preventing blocking and the like of the substrate film. The amount of the additive added is preferably 0.1 to 10% by weight.

Further, for example, ultraviolet absorbers, photostabilizers, antioxidants or the like may be added to the resin composition from the viewpoint of improving lightfastness and the like.

To this end, one or more of the above ultraviolet absorbers, photostabilizers, or antioxidants and the like may be used.

The content of the ultraviolet absorber, the photostabilizer, or the antioxidant is preferably about 0.1 to 10% by weight although it may vary depending upon the shape of particles, density and the like.

The coating agent layer may be formed, for example, by coating a solvent type, aqueous type, emulsion type or other coating agent, for example, by roll coating, gravure roll coating, or kiss coating. The step of coating may be carried out, for example, as a post process after sheet formation or biaxial stretching, or in an inline treatment of film formation or biaxial stretching.

In order to suppress yellowing, deterioration, shrinkage or cohesive failure in a surface layer or an inner layer of the substrate film, to realize the formation of a good deposited film of an inorganic oxide, and to improve the adhesion between the substrate film and the deposited film, a vapor-deposited thin film of an inorganic oxide is formed as a surface pretreatment layer on one side of the substrate film to provide a vapor deposition-resistant protective film, for example, by a chemical vapor deposition process (CVD process), such as a plasma chemical vapor deposition process, a thermal chemical vapor deposition process or a photochemical vapor deposition process which will be described later, or a physical vapor deposition process (PVD process), such as a vacuum evaporation process (resistance heating, dielectric heating, or EB heating), a sputtering process or an ion plating process.

A thin, nonbarrier film not having a barrier property against water vapor gas, oxygen gas or the like suffices as the thickness of the vapor deposition-resistant protective film. Specifically, the thickness of the vapor deposition-resistant protective film is preferably less than 150 angstroms. Specifically, the thickness of the vapor deposition-resistant protective film is in the range of about 10 to about 100 angstroms, preferably in the range of about 20 to 80 angstroms, more preferably in the range of about 30 to about 60 angstroms. When the thickness is not less than 150 angstroms, the formation of a good vapor deposition-resistant protective film disadvantageously becomes difficult. On the other hand, when the thickness is less than 10 angstroms, the function as the vapor deposition-resistant protective layer is not developed.

Next, the vapor-deposited film of an inorganic oxide formed on the substrate will be described. The vapor-deposited film of an inorganic oxide may be single-layer film of a single layer or a multilayered film or composite film of two or more deposited inorganic oxide layers formed, for example, by a physical vapor deposition method or a chemical vapor deposition method, or a combination of the physical vapor deposition method with the chemical vapor deposition method.

The physical vapor deposition process will be described in more detail. For example, vacuum deposition methods (resistance heating, dielectric heating, or EB heating method), sputtering methods, ion plating methods, ion cluster beam methods, or other PVD method may be utilized.

The deposited film may be formed, for example, by a vacuum deposition method in which a metal oxide is provided as a raw material and is heated for vapor deposition on the substrate film, an oxidation reaction deposition method in which a metal or a metal oxide is used as a raw material and oxygen is introduced to cause oxidation for deposition on the substrate film, or a plasma-aided oxidation reaction deposition method in which an oxidation reaction is accelerated by plasma.

In the above methods, the vapor deposition material may be heated, for example, by resistance heating, high frequency induction heating, or electron beam heating.

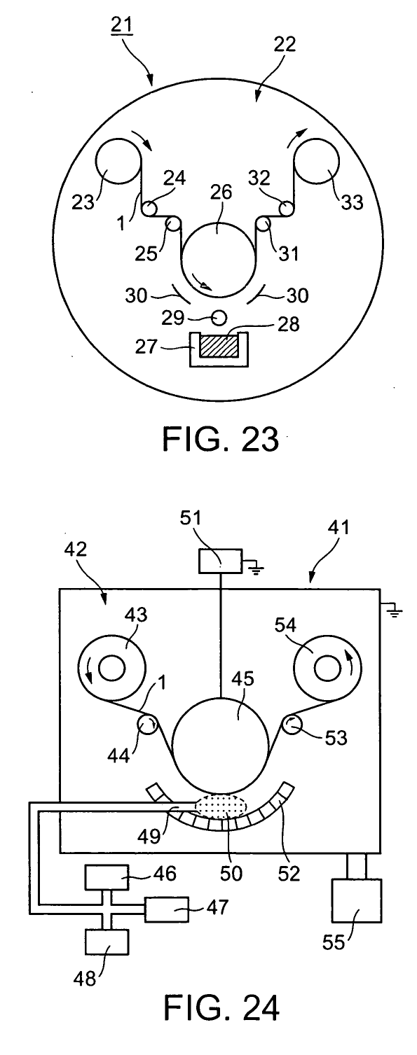

In the present invention, an embodiment of a method for forming a vapor-deposited film of an inorganic oxide by a physical vapor deposition method will be specifically described with reference to FIG. 23. FIG. 23 is a schematic block diagram showing an embodiment of a winding-type vacuum vapor deposition apparatus.

In a vacuum chamber 22 in a winding-type vacuum vapor deposition apparatus 21, a substrate film 1 unwound from an unwinding roll 23 is guided through guide rolls 24, 25 onto a cooled coating drum 26.

A vapor deposition source 28 such as a metallic aluminum or aluminum oxide heated in a crucible 27 is evaporated onto the substrate film 1 guided onto the cooled coating drum 26. Further, if necessary, oxygen gas or the like is jetted through an oxygen gas blowout hole 29, and, while supplying the gas, for example, a vapor-deposited film of an inorganic oxide of aluminum oxide or the like is formed through a mask 30. Next, the substrate film 1 with the vapor-deposited film of an inorganic oxide such as aluminum oxide formed thereon is delivered through guide rolls 31, 32 and wound around a winding roll 33 to form the vapor-deposited film of an inorganic oxide.

In the present invention, a first vapor-deposited film of an inorganic oxide is first formed by using the above winding-type vacuum vapor deposition apparatus, and, subsequently, in the same manner as described above, a vapor-deposited film of an inorganic oxide is further formed on the vapor-deposited film of an inorganic oxide. Alternatively, winding-type vacuum deposition apparatuses of the above type are connected in tandem, and vapor-deposited films of an inorganic oxide are continuously formed to form a multilayered film of two or more layers of an inorganic oxide.

The vapor-deposited film of an inorganic oxide may be basically a thin film formed by vapor deposition of an oxide of a metal. Metals include, for example, silicon (Si), aluminum (Al), magnesium (Mg), calcium (Ca), potassium (K), tin (Sn), sodium (Na), boron (B), titanium (Ti), lead (Pb), zirconium (Zr), and yttrium (Y). Preferred are metals such as silicon (Si) and aluminum (Al).

Metal oxides include silicon oxide, aluminum oxide, and magnesium oxide. These metal oxides have a composition represented by MOₓ such as SiOₓ, AlOₓ, and MgOₓ where M represents a metal element and X varies depening upon the metal element. The value of X is in the range of 0 to 2 for silicon (Si), 0 to 1.5 for aluminum (Al), 0 to 1 for magnesium (Mg), 0 to 1 for calcium (Ca), 0 to 0.5 for potassium (K), 0 to 2 for tin (Sn), 0 to 0.5 for sodium (Na), 0 to 1.5 for boron (B), 0 to 2 for titanium (Ti), 0 to 1 for lead (Pb), 0 to 2 for zirconium (Zr) and 0 to 1.5 for yttrium (Y). When X=0, the vapor-deposited film is formed of a metal only and is not transparent and thus is unfavorable. On the other hand, the upper limit of the range of X is a value corresponding to the complete oxide.

In the present invention, Si and Al are particularly preferred. The value of X of the metal is preferably in the range of 1.0 to 2.0 for Si and in the range of 0.5 to 1.5 for Al.

The thickness of the vapor-deposited film may be, for example, in the range of about 50 to 4000 angstroms, preferably in the range of about 100 to 1000 angstroms although the thickness may vary depending upon the type of the metal or the metal oxide and the like.

A mixture of two or more metals or metal oxides may be used for forming a vapor-deposited film of a composite inorganic oxide.

The vapor-deposited film of an inorganic oxide formed by the chemical vapor deposition method will be described. For example, CVD methods such as a plasma chemical vapor deposition method, a thermal chemical vapor deposition method, or a photochemical vapor deposition method may be utilized as the chemical vapor deposition method. Specifically, the deposited film of an inorganic oxide such as silicon oxide may be formed on one side of the substrate film by a low-temperature plasma chemical vapor deposition method utilizing a low-temperature plasma generator or the like and using an evaporation monomer gas, such as an organic silicon compound gas, as a source gas, an inert gas, such as argon gas or helium gas, as a carrier gas and oxygen gas or the like as an oxygen supply gas.

The low-temperature plasma generator may be a generator such as a radio frequency plasma generating apparatus, a pulse-wave plasma generating apparatus or a microwave plasma generating apparatus. In order to provide highly active stable plasma, the use of a radio-frequency plasma-type generator is preferred.

An embodiment of a method for forming a vapor-deposited film of an inorganic oxide formed by the chemical vapor deposition method according to the present invention will be described with reference to FIG. 24. FIG. 24 is a schematic block diagram of a low-temperature plasma chemical vapor deposition apparatus.

A substrate film 1 is unwound from an unwinding roll 43 disposed within a vacuum chamber 42 in a plasma chemical vapor deposition apparatus 41. Further, the substrate film 1 is transferred on the circumferential surface of a cooling/electrode drum 45 at a predetermined speed through an auxiliary roll 44.

Next, oxygen gas, inert gas, an evaporation monomer gas such as an organic silicon compound and the like are supplied, for example, from gas supplying devices 46, 47 and a starting material volatilization supply device 48, and the evaporation mixed gas composition is introduced into the vacuum chamber 42 through a starting material supply nozzle 49 while regulating the evaporation mixed gas composition. Plasma is generated by glow discharge plasma 50 and applied on the substrate film 1 transferred on the circumferential surface of the cooling/electrode drum 45 to form a vapor-deposited film of an inorganic oxide such as silicon oxide. A predetermined power is applied from a power supply 51 disposed in the outside of the chamber to the cooling/electrode drum 45, and a magnet 52 is disposed around the cooling/electrode drum 45 to promote the generation of plasma.

Next, a deposited film of an inorganic oxide can be produced by winding the substrate film 1 with the deposited film of an inorganic oxide such as silicon oxide formed thereon through an auxiliary roll 53 around a winding roll 54. In the drawing, numeral 55 designates a vacuum pump.

It is a matter of course that the above embodiment is illustrative only and is not intended to limit the present invention.

In the present invention, the vapor-deposited film of an inorganic oxide may have a single-layer structure of an inorganic oxide. Alternatively, the vapor-deposited film may be a multilayered film of two or more layers (not shown). In this case, only one material may be used, or alternatively a mixture of two or more materials may be used. A vapor-deposited film of an inorganic oxide of a mixture of dissimilar materials may also be formed.

In the present invention, at the outset, a vapor-deposited film of an inorganic oxide as a first layer is formed by using the above low-temperature plasma chemical vapor deposition apparatus. Next, in the same manner as described above, a vapor-deposited film of an inorganic oxide is further formed on the vapor-deposited film of an inorganic oxide. Alternatively, low-temperature plasma chemical vapor deposition apparatuses of the above type are connected in tandem, and vapor-deposited films of an inorganic oxide are continuously formed to form a multilayered film of two or more layers of an inorganic oxide. The degree of vacuum within the vacuum chamber is 1×10⁻¹ to 1×10⁻⁸ Torr, preferably 1×10⁻³ to 1×10⁻⁷ Torr.

An organic silicon compound as a starting material is volatilized by a starting material volatilization supply apparatus, and oxygen gas, inert gas or the like supplied from the gas supply apparatus is mixed with the organic silicon compound. This mixed gas is introduced into a vacuum chamber through a starting material supply nozzle.

In this case, in the mixed gas, preferably, the content of the organic silicon compound is 1 to 40%, the content of the oxygen gas is 10 to 70%, and the content of the inert gas is 10 to 60%. For example, the mixing ratio of the organic silicon compound to the oxygen gas to the inert gas may be about 1:6:5 to 1:17:14.

On the other hand, since a predetermined voltage is applied from a power supply to the cooling/electrode drum, glow discharge plasma is generated near the opening in the starting material supply nozzle within the vacuum chamber and the cooling/electrode drum. This glow discharge plasma is led out from one or more gas components in the mixed gas. When the resin film is transferred in this state at a given speed, a vapor-deposited film of an inorganic oxide such as silicon oxide can be formed on the resin film on the circumferential surface of the cooling/electrode drum by the glow discharge plasma.

In this case, the degree of vacuum within the vacuum chamber is preferably about 1×10⁻¹ to 1×10⁻⁴ Torr, more preferably about 1×10⁻¹ to 1×10⁻² Torr. The transfer speed of the resin film is about 10 to 300 m/min, preferably about 50 to 150 m/min. Since the degree of vacuum is lower than the degree of vacuum in the formation of a vapor-deposited film of an inorganic oxide such as silicon oxide by the conventional vacuum deposition method, that is, 1×10⁻⁴ to 1×10⁻⁵ Torr, the vacuum state setting time in the replacement of the original film can be shortened, and, thus, the degree of vacuum is likely to be stabilized and the film formation process is stabilized.

Further, in the plasma chemical vapor deposition apparatus, the vapor-deposited film of an inorganic oxide such as silicon oxide is formed as a thin film in the form of SiOₓ on the resin film while oxidizing the starting material gas converted to plasma with oxygen gas. Therefore, the vapor-deposited film is a continuous layer that is dense, has no significant gap, and is highly flexible. Accordingly, the level of the barrier properties of the vapor-deposited film of an inorganic oxide such as silicon oxide is much higher than that in the case of the vapor-deposited film of an inorganic oxide such as silicon oxide formed by the conventional vacuum deposition method or the like, and satisfactory barrier properties can be realized in a small film thickness. Further, SiOₓ plasma is advantageous in that the surface of the substrate film is cleaned and, at the same time, since polar groups, free radicals and the like are generated on the surface of the substrate film, the adhesion between the vapor-deposited film of an inorganic oxide such as silicon oxide and the substrate film can be improved.

In the vapor-deposited film of silicon oxide formed using an evaporation monomer gas such as an organic silicon compound, the evaporation monomer gas such as an organic silicon compound is chemically reacted with oxygen gas or the like, and the reaction product is adhered on one side of the resin film. Therefore, a thin film, which is dense and is excellent in flexibility and the like, can be formed. The vapor-deposited film is generally a continuous thin film composed mainly of silicon oxide represented by general formula SiOₓ wherein x is a number of 0 to 2.

The vapor-deposited film of silicon oxide is preferably a thin film which is mainly a vapor-deposited film of silicon oxide represented by general formula SiOₓ wherein x is a number of 1.3 to 1.9, for example, from the viewpoints of transparency and barrier properties. The value of x varies depending upon the molar ratio of the evaporation monomer gas to the oxygen gas, plasma energy and the like. In general, however, a decrease in the value of x results in a decrease in gas permeability, yellowing of the film per se, and a decrease in the transparency of the vapor-deposited film.

Further, the vapor-deposited film of silicon oxide is a vapor-deposited film comprising one of carbon, hydrogen, silicon, or oxygen, or at least one of compounds of two or more elements in a chemically bonded state.

For example, such materials include C—H bond-containing compounds, Si—H bond-containing compounds, or materials in which carbon units are in a graphite form, a diamond form, a fullerene form or the like, and materials contain the organic silicon compound as the starting compound or derivatives thereof in chemically bonded form or the like. Specific examples thereof include CH₃ site-containing hydrocarbons, hydrosilicas such as SiH₃ (silyl) and SiH₂ (silylene), or hydroxyl group derivatives such as SiH₂OH (silanol).

Furthermore, the type, amount and the like of the compound contained in the vapor-deposited film of silicon oxide can be varied, for example, by varying conditions for the vapor deposition process.

The content of silicon oxide in the vapor-deposited film is 0.1 to 50% by weight, preferably 5 to 20% by weight. When the silicon oxide content is less than 0.1% by weight, the impact resistance, spreading properties, flexibility and the like of the vapor-deposited film of silicon oxide are unsatisfactory. Therefore, for example, scratches and cracks are likely to occur, for example, upon bending, and it becomes difficult to stably maintain a high level of gas barrier properties. On the other hand, when the silicon oxide content exceeds 50% by weight, the gas barrier properties are disadvantageously deteriorated.

Further, in the vapor-deposited film of silicon oxide, preferably, the content of the above compound decreases from the surface of the vapor-deposited film of silicon oxide toward the direction of the depth. When the content of the compound near the surface is high, by virtue of the above compound, the impact strength on the surface of the vapor-deposited film can be enhanced. On the other hand, at the interface of the substrate film and the vapor-deposited film, since the content of the compound is lower, the adhesion between the substrate film and the vapor-deposited film can be improved.

The above physical properties of the vapor-deposited film of silicon oxide can be determined by the elementary analysis of the vapor-deposited film of silicon oxide, in which the vapor-deposited film of silicon oxide analyzed by ion etching in the direction of the depth with a surface analyzer such as an x-ray photoelectron spectroscope for x-ray photoelectron spectroscopy (XPS) or a secondary ion mass spectroscope for secondary ion mass spectroscopy (SIMS).

The thickness of the vapor-deposited film of silicon oxide is preferably about 50 to about 4000 angstroms, particularly preferably 100 to 1000 angstroms. When the thickness is larger than 4000 angstroms, cracking or the like is likely to occur in the film. On the other hand, when the thickness is less than 50 angstroms, the barrier properties are deteriorated. The film thickness can be measured by a fundamental parameter method, for example, with a fluorescent x-ray spectrometer (model: RIX2000, manufactured by Rigaku Corporation).

The thickness of the vapor-deposited film of silicon oxide can be changed by increasing the deposition rate of the vapor-deposited film, that is, by increasing the flow rates of the monomer gas and oxygen gas or by reducing the deposition rate.

Evaporation monomer gases such as organic silicon compounds for the formation of the vapor-deposited film of an inorganic oxide such as silicon oxide include, for example, 1,1,3,3-tetramethyldisiloxane, hexamethyldisiloxane, vinyl trimethylsilane, methyl trimethylsilane, hexamethyldisilane, methylsilane, dimethylsilane, trimethylsilane, diethylsilane, propylsilane, phenylsilane, vinyl triethoxysilane, vinyl trimethoxysilane, tetramethoxysilane, tetraethoxysilane, phenyltrimethoxysilane, methyltriethoxysilane, octamethylcyclotetrasiloxane and the like. Among them, 1,1,3,3-tetramethyldisiloxane or hexamethyldisiloxane is particularly preferred as the starting material, for example, from the viewpoints of handleability and properties of the formed continuous film.

Inert gases usable herein include, for example, argon gas and helium gas.

The vapor-deposited film of an inorganic oxide according to the present invention may also be a composite film of two or more deposited films of dissimilar inorganic oxides formed, for example, by using a combination of a physical vapor deposition method with a chemical vapor deposition method. The composite film of dissimilar inorganic oxides having a multilayer structure of two or more deposited layers may be formed by first forming a vapor-deposited film of an inorganic oxide, which is dense, is highly flexible, and is relatively less likely to cause cracking, on a substrate film by a chemical vapor deposition method and then providing a vapor-deposited film of an inroganic oxide on the vapor-deposited film of an inorganic oxide by a physical vapor deposition method.

It is a matter of course that the composite film of two or more deposited layers may be formed by carrying out the above steps in a reversed order, that is, by first forming a vapor-deposited film by a physical vapor deposition method and then forming a vapor-deposited film by a chemical vapor deposition method.

Next, the heat resistant polyolefin resin film constituting the backside protective sheet for a solar battery module in the present invention will be described. The polyolefin resin film is formed of a polyethylene resin composition. The polyethylene resin composition is composed mainly of one or at least two polyolefin resins. A light reflecting agent, a light diffusing agent, a light absorbing agent, a decorating agent, one or at least two coloring additives having other functions, one or at least two ultraviolet absorbers, and one or at least two photostabilizers are added thereto. Further, if necessary, one or at least two of plasticizers, antioxidants, antistatic agents, crosslinking agents, curing agents, fillers, lubricants, reinforcing agents, stiffners, flame retardants, flame-resistant agents, foaming agents, antifungal agents, colorants such as pigments and dyes, and other additives may be added. Furthermore, if necessary, a solvent, a diluent or the like is added. The mixture is thoroughly kneaded to prepare a polypropylene resin composition.

When a transparent polyolefin resin film is used, the above coloring additive is of course not contained.

Among the above additives, flam retardants are particularly preferably used. Flame retardants are classified roughly into organic flame retardants and inorganic flam retardants. Organic flame retardants include, for example, phosphorus, phosphorus and halogen, chlorine, and bromine flame retardants. Inorganic flame retardants include, for example, aluminum hydroxide, antimony, magnesium hydroxide, guanidine, zirconium, and zinc borate flame retardants. Any one or two or more of these flame retardants may be added to impart flame retardancy.

In the present invention, the polyolefin resin composition prepared above is formed into a polyolefin resin film or sheet, for example, by a film forming method such as extrusion, T-die extrusion, casting, or inflation using an extruder, a T-die extruder, a casting machine, or an inflation machine, and, if desired, the polyolefin resin film or sheet is uniaxially or biaxially stretched, for example, by a tenter method or a tubular method. Thus, a heat resistant polyolefin resin film with an ultraviolet absorber and a photostabilizer incorporated therein by milling, or a heat resistant polyolefin resin film with a coloring additive, an ultraviolet absorber and a photostabilizer incorporated therein by milling can be prepared.

Alternatively, a multilayered resin film using a resin layer of the polyolefin resin composition prepared above as a core may be prepared as follows. In forming the heat resistant polyolefin resin film with an ultraviolet absorber and a photostabilizer incorporated therein by milling, or with a coloring additive, an ultraviolet absorber and a photostabilizer incorporated therein by milling, for example, the above polyolefin resin composition and a polyolefin resin composition free from the coloring additive, the ultraviolet absorber, and the photostabilizer are provided, and they are coextruded, for example, by a T-die coextrusion method or an inflation coextrusion method.

Alternatively, the polyolefin resin film may be prepared by thoroughly kneading the additives to prepare a coating material or an ink composition, coating the coating material or the ink composition onto the surface of a transparent heat resistant polyolefin resin film, for example, by a conventional coating or printing method to form a coating or print film, and forming, on the surface of the coating film (or the print film), a coating film (or a print film) containing a coloring additive, an ultraviolet absorber, a photostabilizer and the like.

In this case, when the ultraviolet absorber or the photostabilizer is previously incorporated in the transparent heat resistant polypropylene resin film by milling, the ultraviolet absorber or the photostabilizer is not always required to be added to the coating material or the ink composition.

The backside protective sheet for a solar battery module according to the present invention may also be prepared by laminating the transparent/translucent heat resistant polyolefin resin film containing an ultraviolet absorber and a photostabilizer, or the colored heat resistant polyolefin resin film containing a coloring additive, an ultraviolet absorber, and a photostabilizer prepared above on both sides of the deposited assembly, that is, the substrate film with a vapor-deposited film formed on at least one side thereof, by dry lamination through a laminating adhesive layer, or by melt extrusion lamination through an anchor coating agent layer or a melt extruded resin layer.

Alternatively, the backside protective sheet for a solar battery module according to the present invention may be prepared by a melt extrusion lamination method in which the polyolefin resin composition prepared for a milling incorporation-type polyolefin resin film is melt extruded by an extruder to laminate the polyolefin resin film, for example, through an bonding aid layer of an anchor coating agent or the like, or directly without through the bonding aid layer onto both sides of a deposited assembly, that is, a substrate film with a vapor-deposited film formed thereon.

Further, the backside protective sheet for a solar battery module in which both sides are different from each other in hue may be prepared by providing polyolefin resin compositions different from each other in hue (different from each other in type of coloring additive) and melt extruding these polyolefin resin compositions by an extruder or the like onto respective sides of a deposited assembly, that is, a substrate film with a deposited film formed thereon, either through a bonding aid layer of an anchor coating agent or the like or directly without through the bonding aid layer.

The thickness of the polyolefin resin film is preferably about 10 to 300 μm, more preferably 15 to 150 μm.

Polyolefin resins usable in the backside protective sheet for a solar battery module according to the present invention include, for example, polyethylene, high-density polyethylenes, polybutene, poly-4-methylpentene, polyisobutylene, syndiotactic polystyrene, styrene-butadiene-styrene block copolymers, propylene homopolymers, or copolymers of propylene with other monomer(s). They may be used either solely or in a combination of two or more. The use of a polypropylene resin is particularly preferred.

In this case, the polypropylene resin may be a homopolymer of propylene as a by-product produced in the production of ethylene by thermal decomposition of petroleum hydrocarbons, or a copolymer of propylene with α-olefin or other monomer(s).

In the polypropylene resin, when a cationic polymerization catalyst or the like has been used in the polymerization of propylene, a low-molecular weight polymer is obtained, while, when a Ziegler-Natta catalyst has been used, a high-molecular weight and high-crystallinity isotactic polymer is obtained. In the present invention, the use of the isotactic polymer is preferred.

The isotactic polymer has a melting point of 164 to 170° C., a specific gravity of about 0.90 to 0.91, and a molecular weight of about 100000 to 200000. In the case of a polymer having a high level of isotacticity, the properties are greatly governed by the crystallinity. However, the polymer has excellent tensile strength and impact strength, good heat resistance and resistance to fatigue from flex and very good moldability.

In the present invention, when the heat resistant polypropylene resin film is laminated by dry lamination, if necessary, the surface of the heat resistant polypropylene resin film may be previously subjected to surface modification pretreatment such as corona discharge treatment, ozone treatment, or plasma discharge treatment.

The polypropylene resin is more preferably a mixture of a homopolymer of propylene with an ethylene-propylene random copolymer. In the present invention, basically, the propylene homopolymer has a relatively high melting point and a high rigidity. On the other hand, the ethylene-propylene copolymer has a low melting point and low rigidity. When the polymer having a high melting point and the polymer having a low melting point are used as a mixture, the moldable temperature range can be broadened to improve moldability. Further, when the polymer having a high rigidity and the polymer having a low rigidity are used as a mixture, the foldability can be improved and, at the same time, whitening can be prevented and the shape retention can be improved.

The mixing ratio of the propylene homopolymer to the ethylene-propylene random copolymer is preferably 5:95 to 50:50, particularly preferably 10:90 to 30 to 70.

In general, the polypropylene resin used as a heat sealing resin layer (a sealant layer), for example, for packaging materials for filling and packaging of foods or the like is required to be heat sealable in such a low temperature range that heating is carried out at a temperature around 100° C. for a few seconds. Therefore, low-temperature processability is required, and resins having a considerably low melting point have been used. Such low heat resistant polypropylene resins are not suitable for the present invention.

Polypropylene resin films are classified into unstretched types and stretched types. In a room temperature range, stretched types are superior in film strength. However, in the step of heat pressing in the production of a solar battery module, in general, a temperature of 150 to 170° C. is applied for 20 to 30 min. In this case, stretched films are significantly shrunken and thus are unfavorable. For this reason, in the present invention, the use of unstretched films is preferred.

Further, in the present invention, the use of a polypropylene resin having a relatively high melting point is preferred from the viewpoint of heat resistance in the heat pressing. This resin is advantageous in that, for example, hydrolysis of the polypropylene resin can be suppressed, and, in addition, durability against a moist heat resistance test and the like can be improved.

In the present invention, in addition to the above polypropylene resin, if necessary, for example, a polyethylene resin or other resin compatible with the polypropylene resin may be added to modify the polypropylene resin.

In the present invention, the use of the above polypropylene resin is advantageous in the production of a solar battery module in that the adhesion to a filler layer and the like is excellent, and, in addition, moisture resistance for preventing the entry of moisture, oxygen and the like can be significantly improved, long-term performance deterioration can be minimized, and, in particular, for example, deterioration caused by hydrolysis can be prevented, the durability is very high, the protective capability is excellent, and a safe solar battery module can be constructed at a lower cost.

Further, coloring additives include, for example, colorants, for example, various dyes and pigments, for example, achromatic colorants such as whitening agents and blackening agents, or chromatic colorants such as red, orange, yellow, green, blue, purple or other colorants. They may be used either solely or in a combination of two or more.

In the present invention, a method may be adopted in which, for example, a whitening agent may be used in one polyolefin resin layer constituting the protective sheet for a solar battery module while a coloring additive other than white is used in the other polyolefin resin layer. In this case, a protective sheet for a solar battery module can be prepared in which both sides are different from each other in color.

The whitening agent is added from the viewpoint of imparting light reflection, light diffusion or the like for reflection or diffusion of transmitted sunlight in the solar battery module to reutilize this light. Further, the whitening agent has the following additional function and effect. Specifically, the whitening agent can impart design and decoration or the like to the solar battery module and, in addition, can reflect or diffuse reflected sunlight when the solar battery module is installed on a roof and the like. Whitening agents usable herein include basic lead carbonate, basic lead sulfate, basic lead silicate, zinc flower, zinc sulfide, lithopone, antimony trioxide, anatase form of titanium oxide, and rutile form of titanium oxide or other white pigments. They may be used either solely or in a combination of two or more. The amount of the whitening agent used is preferably 0.1 to 30% by weight, particularly preferably 0.5 to 10% by weight, based on the polyolefin resin composition.

In the present invention, gray, achromatic dyes and pigments and the like prepared by mixing the whitening agent with a blackening agent which will be described later can also be used.

The function and effect of the blackening agent are to impart design, decoration and the like suited to a surrounding environment when the solar battery module is installed, for example, on a roof. Blackening agents usable herein include, for example, carbon black (channel or furnace black), black iron oxide and other black pigments. They may be used either solely or in a combination of two or more.

In the present invention, the black layer formed by the blackening agent may be a brownish or bistered black layer, a grayish black layer, or any other blackish black layer.

The amount of the blackening agent used is preferably 0.1 to 30% by weight, particularly preferably 0.5 to 10% by weight, based on the polyolefin resin composition.

Red, orange, yellow, green, blue, purple and other chromatic dyes and pigments include colorants such as various dyes and pigments such as red, orange, yellow, green, blue, indigo, purple and other chromatic dyes and pigments. In the present invention, the function and effect of colorants such as chromatic dyes and pigments are to impart design, decoration and the like suited to a surrounding environment when the solar battery module is installed, for example, on a roof. Such colorants usable herein include, for example, azo, anthraquinone, phthalocyanine, thioindigo, quinacridone, dioxazine or other organic dyes and pigments, or iron blue, chrome vermilion, iron oxide red or other inorganic pigments.

In the present invention, among the chromatic coloring additives, blue bluing agents are particularly preferred.

The amount thereof used is preferably about 0.1 to 30% by weight, particularly preferably 0.5 to 10% by weight, based on the polypropylene resin composition.

The ultraviolet absorber absorbs harmful ultraviolet rays contained in sunlight, converts the energy of ultraviolet rays into harmless thermal energy in its molecules to prevent active species that starts the photodeterioration of polymers from being excited. Examples thereof include benzophenone, benzotriazole, salicylate, acrylonitrile, metallic complex salt, hindered amine, ultrafine particle titanium oxide (particle size: 0.01 to 0.06 μm) or ultrafine particle zinc oxide (particle size: 0.01 to 0.04 μm) or other inorganic ultraviolet absorbers. They may used either solely or in a combination of two or more.

The amount of the ultraviolet absorber added is preferably about 0.1 to 10% by weight, particularly preferably about 0.3 to 10% by weight, based on the polyolefin resin composition.

The photostabilizer captures excited active species as a source that starts photodeterioration in the polymer, thereby preventing photodeterioration. Photostabilizers include, for example, hindered amine compounds and hindered piperidine compounds. They may be used either solely or in a combination of two or more.

The amount of the photostabilizer added is preferably 0.1 to 10% by weight, particularly preferably 0.3 to 10% by weight, based on the polypropylene resin composition.

In the dry lamination method, adhesives usable for constituting the laminating adhesive layer include, for example, polyvinyl acetate adhesives, polyacrylate adhesives including homopolymers of ethyl acrylate, butyl acrylate or 2-ethylhexylester acrylate, or copolymers of those homopolymers and methyl methacrylate, acrylonitrile or styrene or the like, cyanoacrylate adhesives, ethylene copolymer adhesives including copolymers of ethylene with monomers including vinyl acetate, ethyl acrylate, acrylic acid, methacrylic acid and the like, polyolefin adhesives including polyethylene resins or polypropylene resins, cellulose adhesives, polyester adhesives, polyamide adhesives, polyimide adhesives, amino resin adhesives including urea resins or melamine resins, phenolic resin adhesives, epoxy adhesives, polyurethane adhesives, reactive (meth)acrylic adhesives, rubber adhesives including chloroprene rubbers, nitrile rubbers, styrene-butadiene rubbers, or styrene-isoprene rubbers, silicone adhesives, and inorganic adhesives including alkaline metal silicates or low-melting glass.

The composition of the adhesive may be in an aqueous, solution, emulsion, dispersion or other form. Further, the adhesive may be in a film (sheet), powder, solid or other form. The bonding mechanism of the adhesive may be in a chemical reaction, solvent volatilization, heat fusion, thermocompression or other form.

The adhesive may be applied, for example, by coating methods such as roll coating, gravure roll coating, or kiss coating or printing methods. The coverage of the adhesive is preferably 0.1 to 10 g/m² on a dry basis.

In the present invention, rubber adhesives such as styrene-butadiene rubber and styrene-isoprene rubber are particularly preferred as the adhesive. The rubber adhesive has excellent hydrolysis resistance and, at the same time, has the highest cold resistance required of the applications.

In the present invention, in order to cope with high heat resistance, high moist heat resistance and the like, preferably, the vehicle constituting the laminating adhesive is composed mainly of a resin or the like which can be crosslinked or cured to a three-dimensional network crosslinked structure.

Specifically, preferably, the adhesive constituting the laminating adhesive layer forms a crosslinked structure in the presence of a curing agent or a crosslinking agent upon exposure to reactive energy such as heat or light. In the present invention, the adhesive constituting the laminating adhesive layer can form a crosslinked structure in the presence of an isocyanate curing agent or crosslinking agent such as an aliphatic/alicyclic isocyanate or an aromatic isocyanate upon exposure to reactive energy of heat or light to provide a backside protective sheet for a solar battery module that has excellent heat resistance, moist heat resistance and the like.

Aliphatic isocyanates usable herein include, for example, 1,6-hexamethylene diisocyanate (HDI), alicyclic isocyantes usable herein include, for example, isophorone diisocyanate (IPDI), and aromatic isocyanates usable herein include, for example, tolylene diisocyanate (TDI), diphenylmethane diisocyanate (MDI), naphthylene diisocyanate (NDI), tolidine diisocyanate (TODI), and xylylene diisocyanate (XDI).

In order to prevent ultraviolet deterioration or the like, the above-described ultraviolet absorbers or photostabilizers may be added to the adhesive.

One or more of the above ultraviolet absorbers and one or more of the above photostabilizers may be used. The amount thereof used is preferably about 0.1 to 10% by weight although it varies depending upon the shape of particles, density and the like.

In the melt extrusion lamination method, in order to achieve higher bonding strength, for example, the layers may be laminated, for example, through a layer of a bonding aid such as an anchor coating agent.

Anchor coating agents usable herein include, for example, organotitanium anchor coating agents such as alkyl titanate anchor coating agents, and isocyanate, polyethyleneimine, polybutadiene or other aqueous or oily various anchor coating agents.

The anchor coating agent may be coated, for example, by a coating method such as roll coating, gravure roll coating, or kiss coating. The coverage of the anchor coating agent is preferably 0.1 to 5.0 g/m² on a dry basis.

Further, in the melt extrusion lamination method, resins usable for melt extrusion to form a melt extruded resin layer include, for example, low-density polyethylenes, medium-density polyethylenes, high-density polyethylenes, straight-chain (linear) low-density polyethylenes, polypropylenes, ethylene-vinyl acetate copolymers, ionomer resins, ethylene-ethyl acrylate copolymers, ethylene-acrylic acid copolymers, ethylene-methacrylic acid copolymers, ethylene-propylene copolymers, and methyl pentene polymers, and acid-modified polyolefin resins produced by modifying polyolefin resins, such as polyethylene resins or polypropylene resins, by an unsaturated carboxylic acid, such as acrylic acid, methacrylic acid, maleic anhydride, or fumaric acid.

The thickness of the melt extruded resin layer is preferably about 5 to 100 μm, particularly preferably about 10 to 50 μm.

In the present invention, if necessary, for example, a primer coating agent layer may be previously formed as a surface treatment layer from the viewpoint of improving adhesion between the substrate film with a vapor-deposited film of an inorganic oxide formed thereon and the heat resistant polypropylene resin film containing a coloring additive, an ultraviolet absorber, and a photostabilizer.

The primer coating agent usable herein may be, for example, a resin composition comprising a vehicle composed mainly of a polyester resin, a polyamide resin, a polyurethane resin, an epoxy resin, a phenolic resin, an (meta)acrylic resin, a polyvinyl acetate resin, a polyolefin resin such as a polyethylene, or a polypropylene or a copolymer or a resin obtained by modifying one of those resins, a cellulose resin or the like.

In the present invention, the primer coating agent layer may be formed by a coating method such as roll coating, gravure roll coating, or kiss coating. The coverage of the primer coating agent layer is preferably about 0.1 to 5.0 g/m² on a dry basis.

Next, in the present invention, the backside protective sheet for a solar battery module according to the present invention and the heat sealing resin layer constituting the solar battery module or the like will be described. The term “heat sealing resin layer” as used herein refers to the same or dissimilar thermoplastic resins which have been joined to each other by heat, and the heat sealing resin has the function of being bonded to a material to be sealed by a heat lamination process or a sealing process.

The heat sealing resin may be any resin that can be melted by heat to cause mutual fusion. Examples of heat sealing resins usable herein include low-density polyethylenes, medium-density polyethylenes, high-density polyethylenes, straight-chain (linear) low-density polyethylenes, polypropylenes, ethylene-vinyl acetate copolymers, ionomer resins, ethylene-ethyl acrylate copolymers, ethylene-acrylic acid copolymers, ethylene-methacrylic acid copolymers, ethylene-propylene copolymers, and methyl pentene polymers, and polyolefin resins such as acid-modified polyolefin resins produced by modifying polyolefin resins, such as polyethylene resins or polypropylene resins, by an unsaturated carboxylic acid, such as acrylic acid, methacrylic acid, maleic anhydride, or fumaric acid, polyacrylic or polymethacryic resins, polyester resins, polyamide resins, and polyurethane resins. For example, a film or sheet or a coating film of one or more of the above resins may be used,

The resin film or sheet may have a single-layer structure or a multilayer structure. The thickness of the resin film or sheet is about 5 to 300 μm, preferably about 10 to 200 μm.

The heat sealing resin layer may be laminated by providing the above resin film or sheet and laminating the resin film or sheet onto the other side of the substrate film with a vapor-deposited film of an inorganic oxide formed thereon, or the other side of the superimposed laminate by dry lamination, for example, through a laminating adhesive layer, or by melt extrusion lamination, for example, through an anchor coating agent layer or melt extruded resin layer.

Alternatively, the heat sealing resin layer may be laminated by a melt extrusion lamination method which comprises preparing a resin composition using one or at least two of the above resin as a vehicle, and melt extruding the resin composition, for example, by an extruder onto the other side of the substrate film with a vapor-deposited film of an inorganic oxide formed thereon, or the other side of the superimposed laminate, for example, through a bonding aid layer of an anchor coating agent or the like.

Further, in the present invention, the heat sealing resin layer may be laminated by a method which comprises preparing a resin composition using one or at least two of the above resin as a vehicle, and printing or coating the resin composition onto the other side of the substrate film with a vapor-deposited film of an inorganic oxide formed thereon, or the other side of the superimposed laminate, for example, by a conventional printing or coating method to form a printing or coating film.

In this case, the thickness of the heat sealing resin layer is about 1 to 50 μm, preferably about 3 to 10 μm.

According to the present invention, in the lamination of the heat sealing resin layer, the above-described laminating adhesive, anchor coating agent, melt extrusion resin, primer coating agent and the like may be used.

Next, in the present invention, when two or more superimposed laminates, that is, two or more substrate films each with a vapor-deposited film of an inorganic oxide formed thereon, are superimposed on top of each other, or when two or more substrate films each with a vapor-deposited film of an inorganic oxide formed thereon, are superimposed on top of each other through a tough resin film, in the same manner as in the formation of the heat resistant polyolefin resin film, the superimposition may be carried out, for example, by a dry lamination method in which dry lamination is carried out, for example, through a laminating adhesive layer, or by a melt extrusion lamination method in which melt extrusion lamination is carried out, for example, through an anchor coating agent layer or a melt extruded resin layer.

When the dry lamination method or the melt extrusion lamination method or the like is used, the above-described laminating adhesive, anchor coating agent, melt extrusion resin, primer coating agent or the like may be used in the same manner as described above.

The tough resin film constituting the backside protective sheet for a solar battery module and the solar battery module and the like according to the present invention functions to hold the strength, rigidity, nerve and the like of the solar battery module per se and to prevent a deterioration in strength by hydrolysis caused by the entry of moisture or the like in the solar battery module or the like, or a deterioration in strength caused by degasification of vinyl acetate gas or the like produced as a result of the decomposition of the filler layer or the like constituting the solar battery module. Accordingly, the tough resin film should have excellent mechanical, physical, and chemical properties, and should be particularly excellent in strength as well as in various properties such as weathering resistance, heat resistance, water resistance, light resistance, wind pressure resistance, hailstorm resistance, chemical resistance, moisture resistance and other various properties, and, in addition, should be significantly improved in the moisture resistance which is the ability to prevent the entry of moisture, oxygen and the like, and should minimize a long-term performance deterioration, should be able to prevent a deterioration caused by hydrolysis or the like, should be highly durable, and should be excellent in protective capability.

Specific examples of tough resin films usable herein include films or sheets of tough resins such as polyester resins, polyamide resins, polyaramid resins, polypropylene resins, polycarbonate resins, polyacetal resins, polystyrene resins, and fluororesins.

The tough resin film (sheet) may be any of unstreatched films or uniaxially or biaxially stretched films and the like.

The thickness of the tough resin film (sheet) may be the minimum thickness that is necessary for holding strength, rigidity, nerve and the like. When the thickness is excessively large, the cost is increased. On the other hand, when the thickness is excessively small, the strength, rigidity, nerve and the like are disadvantageously deteriorated. Specifically, the thickness is preferably 10 to 200 μm, particularly preferably 30 to 100 μm.

The conventional surface protective sheet for a solar battery module used in the solar battery module according to the present invention should have protective sheet properties, for example, permeability to sunlight and insulating properties, should have weathering resistance, heat resistance, light resistance, water resistance, wind pressure resistance, hailstorm resistance, chemical resistance, moisture resistance, antifouling properties and other various properties, and, in addition, should be excellent in physical or chemical strength and toughness and the like, should be highly durable, and, from the viewpoint of protecting the solar battery element as a photovoltaic element, should be excellent in scratch resistance, impact absorption and the like.

For example, conventional glass plates and the like may of course be used as the surface protective sheet. Additional surface protective sheets usable herein include, for example, films or sheets of various resins such as fluororesins, polyamide resins (various nylons), polyester resins, polyethylene resins, polypropylene resins, cyclic polyolefin resins, polystyrene resins, (meth)acrylic resins, polycarbonate resins, acetal resins, or cellulose resins.

The resin film or sheet may be, for example, a biaxially stretched resin film or sheet.

The thickness of the resin film or sheet is preferably about 12 to 200 μm, particularly preferably about 25 to 150 μm.

The filler layer underlying the surface protective sheet should be transparent to incident sunlight, which should reach the solar battery module without being absorbed, and further should be adhesive to the surface protective sheet and the backside protective sheet. The filler layer should be thermoplastic to keep the surfaces of the solar battery elements, i.e., photovoltaic elements, flat and smooth and should be excellent in scratch resistance and impact absorbing property to protect the solar battery elements, i.e., photovoltaic elements.

Materials suitable for forming the filler layer are, for example, fluororesins, ethylene-vinyl acetate copolymers, ionomer resins, ethylene-acrylic acid or ethylene-methacrylic acid copolymers, polyethylene resins, polypropylene resins, acid-modified polyolefin resins produced by modifying polyolefin resins, such as polyethylene resins or polypropylene resins, by unsaturated carboxylic acid, such as acrylic acid, itaconic acid, maleic acid or fumaric acid, polyvinyl butyral resins, silicone resins, epoxy resins, and (meth)acrylic resins. They may be used either solely or as a mixture of two or more.

In the present invention, if necessary, the resin constituting the filler layer may contain additives including a crosslinking agent, a thermal oxidation inhibitor, a light stabilizer, an ultraviolet absorber and a photooxidation inhibitor in such an amount that will not affect adversely to the transparency of the resin to improve, for example, the weathering resistance properties including heat resistance, light resistance and water resistance.

From the viewpoints of weathering resistance such as light resistance, heat resistance and water resistance, the filler on the sunlight incident side is preferably formed of a fluororesin, a silicone resin, or an ethylene-vinyl acetate resin. The thickness of the filler layer is preferably 200 to 1000 μm, particularly preferably 350 to 600 μm.

Solar battery elements usable as the photovoltaic element constituting the solar battery module in the present invention include conventional solar battery elements, for example, crystalline silicone solar battery elements such as single-crystal silicon solar battery elements and polycrystalline solar battery elements, single junction-type, tandem structure-type or other amorphous silicon solar battery elements, group III-V compound semiconductor solar battery elements such as gallium arsenide (GaAs) or indium phosphide (InP) compound semiconductor solar battery elements, group II-VI compound semiconductor solar battery elements such as cadmium tellurium (CdTe) or copper indium selenide (CuInSe₂) compound semiconductor solar battery elements, and organic solar battery elements.

Further, for example, hybrid elements formed by combining a thin-film polycrystalline silicon solar battery element, a thin-film microcrystalline silicon solar battery element, or a thin-film silicon crystalline solar battery element with anamorphous silicon solar battery element may also be used.

The construction of the solar battery element is, for example, such that crystalline silicon with a p-n junction structure or the like, amorphous silicon with a p-i-n junction structure or the like, and an electromotive force part such as a compound semiconductor are provided on a glass substrate, a plastic substrate, a metallic substrate, or other substrate.

As with the filler layer underlying the surface protective sheet, the filler layer underlying the solar battery element as a photovoltaic element should have adhesion to the backside protective sheet, should be thermoplastic from the viewpoint of the function of holding the smoothness of the backside of the solar battery element, and further should be excellent in scratch resistance, impact absorption and the like from the viewpoint of preventing the solar battery element as the photovoltaic element. Unlike the filler described above, the filler layer underlying the solar battery element is not always required to be transparent.

Specifically, the above filler layer may be formed of the same resin as used in the filler layer underlying the surface protective sheet for a solar battery module.

As with the upper filler layer, if necessary, any additive may be added to and mixed with the resin constituting the filler layer from the viewpoint of improving, for example, weathering resistance such as heat resistance, light resistance, and water resistance.

The thickness of the filler layer is preferably about 200 to 1000 μm, particularly preferably about 350 to 600 μm.

In the present invention, in producing the solar battery module according to the present invention, in order to improve various fastness properties such as strength, weathering resistance, and scratch resistance, a film or sheet of other material may be sued. Materials usable herein include conventional resins such as low-density polyethylenes, medium-density polyethylenes, high-density polyethylenes, linear low-density polyethylenes, polypropylenes, ethylene-propylene copolymers, ethylene-vinyl acetate copolymers, ionomer resins, ethylene-ethyl acrylate copolymers, ethylene-acrylate or -methacrylate copolymers, methyl pentene polymers, polybutene resins, polyvinyl chloride resins, polyvinyl acetate resins, polyvinylindene chloride resins, vinyl chloride-vinylidene chloride copolymers, poly(meta)acrylic resins, polyacrylonitrile resins, polystyrene resins, acrylonitrile-styrene copolymers (AS resins), acrylonitrile-butadiene-styrene copolymers (ABS resins), polyester resins, polyamide resins, polycarbonate resins, polyvinyl alcohol resins, saponified ethylene-vinyl acetate copolymers, fluororesins, diene resins, polyacetal resins, polyurethane resins, or nitrocellulose.

In the present invention, the film or sheet may be either unstretched or uniaxially or biaxially stretched. The thickness of the film or sheet may be selected in the range of from several micrometers to about 300 μm. Further, in the present invention, the film or sheet may be formed, for example, by extrusion film formation, inflation film formation, or coating.

Next, the process for producing a solar battery module using the above material according to the present invention will be described. A conventional production process may be used as the production process of the solar battery module. For example, the solar battery module may be produced using the backside protective sheet for a solar battery module according to the present invention as follows. Specifically, a surface protective sheet for a solar battery module, a filler layer, a solar battery element, a filler layer, and the backside protective sheet for a solar battery module according to the present invention are stacked on top of each other in that order so that the surface of one polypropylene resin film in the backside protective sheet faces the filler layer. Further, if desired, other material is interposed between adjacent layers. The laminate is then subjected to integral molding by heat pressing under vacuum suction or the like to produce a solar battery module.

Preferably, the coloring additive-containing polyolefin resin layer constituting the backside protective sheet is disposed on the inner side of the solar battery module (side remote from sunlight incident side), and the transparent/translucent polyolefin resin layer free from the coloring additive is disposed on the outer side of the solar battery module (sunlight incident side).

If desired, in order to enhance the adhesion between layers or the like, for example, a hot-melt adhesive, a solvent adhesive, a photocurable adhesive or the like containing a (meta)acrylic resin, an olefin resin, a vinyl resin or the like as a main component of the vehicle may also be used.

Further, in the backside protective sheet according to the present invention, in order to improve the adhesion between the contact surfaces of the adjacent layers, if necessary, the surface of each layer may be subjected to pretreatment such as corona discharge treatment, ozone treatment, low-temperature plasma treatment such as oxygen gas or nitrogen gas, glow discharge treatment, or oxidation treatment with a chemical or the like.

Furthermore, if necessary, the contact surfaces of the adjacent layers may be previously subjected to surface pretreatment, for example, by forming a primer coating agent layer, an undercoating agent layer, an adhesive layer, or an anchor coating agent layer.

The coating agent layer for the pretreatment may be formed of, for example, a resin composition comprising a vehicle composed mainly of a polyester resin, a polyamide resin, a polyurethane resin, an epoxy resin, a phenolic resin, an (meta)acrylic resin, a polyvinyl acetate resin, a polyolefin resin such as a polyethylene and a polypropylene or a copolymer or a resin obtained by modifying one of those resins, a cellulose resin or the like.

The coating agent layer may be formed, for example, by providing a solvent-type, an aqueous-type, emulsion-type or other coating agent and coating the coating agent by a coating method such as roll coating, gravure roll coating, or kiss coating.

Further, the solar battery module according to the present invention may also be produced by stacking the above filler layer on the surface of any one of polyolefin resin film in the backside protective sheet to prepare a laminate of the backside protective sheet for a solar battery module and the filler layer, and then stacking a solar battery element as a photovoltaic element, a filler layer, and a surface protective sheet for a solar battery module in that order on the surface of the filler layer in the laminate.

### EXAMPLES

The following Examples further illustrate the present invention.

### Example A1

(1) A 12 μm-thick biaxially stretched polyethylene terephthalate film in which both sides thereof had been corona treated (hereinafter referred to as “biaxially stretched PET film”) was provided as a substrate film. 99.9% pure silicon monoxide (SiO) was heated and evaporated under a vacuum of 1×10⁻⁴ Torr by an induction dielectric heating system to form an 800 angstrom-thick deposited film of silicon oxide on the corona-treated surface.

(2) Separately, titanium oxide (5% by weight) as a whitening agent, ultrafine particle titanium oxide (particle diameter 0.01 to 0.06 μm, 3% by weight) as an ultraviolet absorber and a benzophenone ultraviolet absorber (1% by weight) also as the ultraviolet absorber, a hindered amine photostabilizer (1% by weight) as a photostabilizer, and other necessary additives were added to a polypropylene resin. The mixture was kneaded thoroughly to prepare a polypropylene resin composition which was then melt extruded through a T die extruder to prepare a 60 μm-thick white colored nonstretched polypropylene resin film. Further, both sides of the white colored nonstretched polypropylene resin film were subjected to corona discharge treatment by a conventional method to form corona-treated surfaces.

(3) Next, a two-component curable urethane adhesive for lamination containing a benzophenone ultraviolet absorber (2.0% by weight) as an ultraviolet absorber was gravure roll coated onto one corona-treated surface of the white colored nonstretched polypropylene resin film prepared in the above step (2) to a coating thickness of 5.0 g/m² on a dry basis to form a laminating adhesive layer.

Next, the biaxially stretched polyethylene terephthalate film with an 800 angstrom-thick silicon oxide vapor-deposited film formed thereon prepared in the above step (1) was put on top of the laminating adhesive layer formed above so that the surface of the 800 angstrom-thick silicon oxide vapor-deposited film faced the surface of the laminating adhesive layer, followed by dry lamination of the two films.

(4) Further, a separate white colored nonstretched polypropylene resin film prepared in the above step (2) was provided. In the same manner as described above, a two-component curable urethane adhesive for lamination containing a benzophenone ultraviolet absorber (2.0% by weight) as an ultraviolet absorber was gravure roll coated onto one corona-treated surface of the white colored nonstretched polypropylene resin film prepared in the above step (2) to a coating thickness of 5.0 g/m² on a dry basis to form a laminating adhesive layer.

Next, the biaxially stretched PET film with an 800 angstrom-thick silicon oxide vapor-deposited film formed thereon subjected to dry lamination in the above step (3) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(5) Next, the backside protective sheet for a solar battery module was used for the production of a solar battery module. Specifically, a 3 mm-thick glass plate, a 400 μm-thick ethylene-vinyl acetate copolymer sheet, a 38 μm-thick biaxially stretched PET film with solar battery elements of amorphous silicone juxtaposed to each other thereon, a 400 μm-thick ethylene-vinyl acetate copolymer sheet, and the backside protective sheet for a solar battery module were stacked on top of each other so that the surface of one of the white colored nonstretched polypropylene resin films faced inside, the surface of the solar battery element faced upward and stacking was carried out through an acrylic resin adhesive layer to produce a solar battery module according to the present invention.

### Examples A2 to A4

The backside protective sheet for a solar battery module, and the solar battery module according to the present invention were produced in the same manner as in Example A1, except that the following substrate film was used as the substrate film instead of the 12 μm-thick biaxially stretched PET film in which both sides thereof had been subjected to corona treatment.

Example A2: 100 μm-thick polydicyclopentadiene resin sheet

Example A3: 50 μm-thick polycarbonate resin sheet

Example A4: 50 μm-thick polyacrylic resin sheet

### Example B1

(1) A vapor-deposited substrate film as prepared in Example A1 (1) and a white colored nonstretched polypropylene resin film as prepared in Example A1 (2) were prepared.

(2) Further, carbon black (50 % by weight), i.e., a blackening agent, as a coloring additive, ultrafine particle titanium oxide (particle diameter 0.01 to 0.06 μm, 30% by weight) as an ultraviolet absorber and a benzophenone ultraviolet absorber (1% by weight) also as the ultraviolet absorber, a hindered amine photostabilizer (1% by weight) as a photostabilizer, and other necessary additives were added to a polypropylene resin. The mixture was kneaded thoroughly to prepare a polypropylene resin composition which was then melt extruded through a T die extruder to prepare a 60 μm-thick black colored nonstretched polypropylene resin film. Further, both sides of the black colored nonstretched polypropylene resin film were subjected to corona discharge treatment by a conventional method to form corona-treated surfaces.

(3) In the same manner as in Example A1 (3), the white colored nonstretched polypropylene resin film was put on top of the biaxially stretched PET film so that the white colored nonstretched polypropylene resin film faced the surface of the vapor-deposited film of silicon oxide in the biaxially stretched PET film, followed by dry lamination of both the films. For the black colored nonstretched polypropylene resin film as well, a laminating adhesive layer was formed in the same manner as in the white colored nonstretched polypropylene resin film. The surface of the laminating adhesive layer was allowed to face and put on top of the corona-treated surface of the biaxially stretched PET film, followed by dry lamination of both the films to prepare a backside protective sheet for a solar battery module.

(4) Next, the backside protective sheet for a solar battery module was used for the production of a solar battery module. Specifically, a 3 mm-thick glass plate, a 400 μm-thick ethylene-vinyl acetate copolymer sheet, a 38 μm-thick biaxially stretched PET film with solar battery elements of amorphous silicone juxtaposed to each other thereon, a 400 μm-thick ethylene-vinyl acetate copolymer sheet, and the backside protective sheet for a solar battery module were stacked on top of each other so that the surface of one of the white colored nonstretched polypropylene resin films faced inside, the surface of the solar battery element faced upward and stacking was carried out through an acrylic resin adhesive layer to produce a solar battery module according to the present invention.

### Example B2

The backside protective sheet for a solar battery module as prepared in Example B1 was used for the production of a solar battery module. Specifically, a 3 mm-thick glass plate, a 400 μm-thick ethylene-vinyl acetate copolymer sheet, a 38 μm-thick biaxially stretched PET film with solar battery elements of amorphous silicone juxtaposed to each other thereon, a 400 μm-thick ethylene-vinyl acetate copolymer sheet, and the backside protective sheet for a solar battery module were stacked on top of each other so that the surface of one of the black colored nonstretched polypropylene resin films faced inside, the surface of the solar battery element faced upward and stacking was carried out through an acrylic resin adhesive layer to produce a solar battery module according to the present invention.

### Example B3

(1) The biaxially stretched PET film with an 800 angstrom-thick silicon oxide vapor-deposited film formed thereon as prepared in Example B1 and the 60 μm-thick white colored nonstretched polypropylene resin film as prepared in Example A1 were provided. A styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the white colored nonstretched polypropylene resin film to a coating thickness of 5.0 g/m² on a dry basis to form a laminating adhesive layer.

Next, the biaxially stretched PET film with an 800 angstrom-thick silicon oxide vapor-deposited film formed thereon prepared in Example B1 was put on top of the laminating adhesive layer formed above so that the surface of the 800 angstrom-thick silicon oxide vapor-deposited film faced the surface of the laminating adhesive layer, followed by dry lamination of the two films.

(2) Next, in the same manner as in the above step (1), a styrene-butadiene rubber adhesive into which a crosslinking network of an aromatic isocyanate curing agent containing a benzophenone ultraviolet absorber (20.0% by weight) as an ultraviolet absorber had been introduced was gravure roll coated onto the corona-treated surface of the dry laminated biaxially stretched polyethylene terephthalate film with an 800 angstrom-thick silicon oxide vapor-deposited film formed thereon to a coating thickness of 5.0 g/m² on a dry basis to form a laminating adhesive layer.

Next, the biaxially stretched PET film with an 800 angstrom-thick silicon oxide vapor-deposited film formed thereon as prepared in Example B1 was put on top of the laminating adhesive layer formed above so that the surface of the 800 angstrom-thick silicon oxide vapor-deposited film faced the surface of the laminating adhesive layer, followed by dry lamination of the two films to superimpose the biaxially stretched polyethylene terephthalate film with an 800 angstrom-thick silicon oxide vapor-deposited film formed thereon.

(3) Separately, the 60 μm-thick black colored nonstretched polypropylene resin film as prepared in Example B1 was provided. In the same manner as described above, a styrene-butadiene rubber adhesive into which a crosslinking network of an aromatic isocyanate curing agent containing a benzophenone ultraviolet absorber (2.0% by weight) as an ultraviolet absorber had been introduced was gravure roll coated onto one corona-treated surface of the black colored nonstretched polypropylene resin film to a coating thickness of 5.0 g/m² on a dry basis to form a laminating adhesive layer.

Next, the biaxially stretched PET film with an 800 angstrom-thick silicon oxide vapor-deposited film formed thereon subjected to dry lamination for superimposition in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, the backside protective sheet for a solar battery module was used for the production of a solar battery module. Specifically, a 3 mm-thick glass plate, a 400 μm-thick ethylene-vinyl acetate copolymer sheet, a 38 μm-thick biaxially stretched PET film with solar battery elements of amorphous silicone juxtaposed to each other thereon, a 400 μm-thick ethylene-vinyl acetate copolymer sheet, and the backside protective sheet for a solar battery module were stacked on top of each other so that the surface of one of the white colored nonstretched polypropylene resin films faced inside, the surface of the solar battery element faced upward and stacking was carried out through an acrylic resin adhesive layer to produce a solar battery module according to the present invention.

### Example B4

The backside protective sheet for a solar battery module as prepared in Example B3 was used for the production of a solar battery module. Specifically, a 3 mm-thick glass plate, a 400 μm-thick ethylene-vinyl acetate copolymer sheet, a 38 μm-thick biaxially stretched PET film with solar battery elements of amorphous silicone juxtaposed to each other thereon, a 400 μm-thick ethylene-vinyl acetate copolymer sheet, and the backside protective sheet for a solar battery module were stacked on top of each other so that the surface of one of the black colored nonstretched polypropylene resin films faced inside, the surface of the solar battery element faced upward and stacking was carried out through an acrylic resin adhesive layer to produce a solar battery module according to the present invention.

### Example B5

(1) A 12 μm-thick biaxially stretched polyethylene terephthalate film in which both surfaces thereof had been subjected to corona treatment was provided as a substrate film. The substrate film was mounted on a delivery roll in a plasma chemical vapor deposition apparatus, and an 800 angstrom-thick (80 nm-thick) vapor-deposited film of silicon oxide was formed on one corona-treated surface of the biaxially stretched polyethylene terephthalate film under the following conditions.

(Vapor Deposition Conditions)

Reaction gas mixing ratio: Hexamethyldisiloxane:oxygen gas:helium=1:10:10 (unit:slm)

Degree of vacuum in vacuum chamber: 5.0×10⁻⁶ mbar

Degree of vacuum in vapor deposition chamber: 6.0×10⁻² mbar

Power supplied to cooling electrode drum: 20 kW

Film moving speed: 80 m/min

(2) The white colored nonstretched polypropylene resin film as used in Example B1 was then provided. A styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the white colored nonstretched polypropylene resin film to a coating thickness of 5.0 g/m² on a dry basis to form a laminating adhesive layer.

Next, the biaxially stretched PET film with an 800 angstrom-thick silicon oxide vapor-deposited film formed thereon as prepared in the above step (1) was put on top of the laminating adhesive layer formed above so that the surface of the 800 angstrom-thick silicon oxide vapor-deposited film faced the surface of the laminating adhesive layer, followed by dry lamination of the two films.

(3) Next, in the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the dry laminated biaxially stretched PET film to a coating thickness of 5.0 g/m² on a dry basis to form a laminating adhesive layer.

Next, a 50 μm-thick biaxially stretched PET film, in which both surfaces thereof had been subjected to corona treatment, was put on top of the laminating adhesive layer formed above so that one corona-treated surface faced the surface of the laminating adhesive layer, followed by dry lamination of the two films.

(4) Next, in the same manner as described above, a styrene-butadiene rubber adhesive into which a crosslinking network of an aromatic isocyanate curing agent containing a benzophenone ultraviolet absorber (2.0% by weight) as an ultraviolet absorber had been introduced was gravure roll coated onto the other corona-treated surface of the dry laminated 50 μm-thick biaxially stretched PET film to a coating thickness of 5.0 g/m² on a dry basis to form a laminating adhesive layer.

(5) Separately, the black colored nonstretched polypropylene resin film as prepared in Example B1 was provided. In the same manner as described above, a styrene-butadiene rubber adhesive into which a crosslinking network of an aromatic isocyanate curing agent containing a benzophenone ultraviolet absorber (2.0% by weight) as an ultraviolet absorber had been introduced was gravure roll coated onto one corona-treated surface of the black colored nonstretched polypropylene resin film to a coating thickness of 5.0 g/m² on a dry basis to form a laminating adhesive layer.

Next, the biaxially stretched PET film with an 800 angstrom-thick silicon oxide vapor-deposited film formed thereon subjected to dry lamination for superimposition in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(6) Next, a solar battery module was prepared in the same manner as in Example B3, except that the above backside protective sheet for a solar battery module was used.

### Example B6

(1) A 12 μm-thick biaxially stretched polyethylene terephthalate film in which both surfaces thereof had been subjected to corona treatment was provided as a substrate film. The substrate film was mounted on a delivery roll in a plasma chemical vapor deposition apparatus, and a 50 angstrom-thick vapor-deposited film of silicon oxide was formed on one corona-treated surface of the biaxially stretched polyethylene terephthalate film under the following conditions to form a deposition-resistant protective film.

(Vapor Deposition Conditions)

Reaction gas mixing ratio: Hexamethyldisiloxane:oxygen gas:helium=5:5:5 (unit:slm)

Degree of vacuum in vacuum chamber: 7.0×10⁻⁶ mbar

Degree of vacuum in vapor deposition chamber: 3.8×10⁻² mbar

Power supplied to cooling electrode drum: 15 kW

Film moving speed: 100 m/min

Next, a backside protective sheet for a solar battery module and a solar battery module were prepared on the deposition-resistant protective film in the same construction as in Example B4.

### Example C1

A 12 μm-thick biaxially stretched PET film with one anchor coated surface was provided as a substrate film. The biaxially stretched PET film was first mounted on a delivery roll in a winding-type vacuum vapor deposition apparatus. The biaxially stretched PET film was then unwound, and an 800 angstrom-thick vapor-deposited film of silicon oxide was formed on the anchor coated surface of the biaxially stretched PET film by a resistance heating type vacuum vapor deposition method using silicon monoxide (SiO) as a vapor deposition source while feeding oxygen gas under the following vapor deposition conditions.

(Vapor Deposition Conditions)

Degree of vacuum in vacuum chamber: 1.33×10⁻² Pa (1×10⁻⁴ Torr)

Degree of vacuum in winding chamber: 1.33×10⁻² Pa

Film moving speed: 100 m/min

Surface for vapor deposition: anchor coated surface

(2) Next, ultrafine particle titanium oxide (particle diameter 0.01 to 0.06 μm, 3% by weight) as an ultraviolet absorber and a benzophenone ultraviolet absorber (1% by weight) also as the ultraviolet absorber, a hindered amine photostabilizer (1% by weight) as a photostabilizer, and other necessary additives were added to a polypropylene resin. The mixture was kneaded thoroughly to prepare a polypropylene resin composition which was then melt extruded through a T die extruder to prepare an 80 μm-thick transparent nonstretched polypropylene resin film. Further, both sides of the transparent nonstretched polypropylene resin film were subjected to corona discharge treatment by a conventional method to form corona-treated surfaces.

(3) The biaxially stretched PET film with an 800 angstrom-thick silicon oxide vapor-deposited film formed thereon and the 80 μm-thick transparent nonstretched polypropylene resin film were provided. A styrene-butadiene rubber adhesive into which a crosslinking network of an aromatic isocyanate curing agent containing a benzophenone ultraviolet absorber (2% by weight) as an ultraviolet absorber had been introduced was first gravure roll coated onto one corona-treated surface of the transparent nonstretched polypropylene resin film to a coating thickness of 5.0 g/m² on a dry basis to form a laminating adhesive layer.

Next, the biaxially stretched PET film with an 800 angstrom-thick silicon oxide vapor-deposited film formed thereon prepared above was put on top of the laminating adhesive layer formed above so that the surface of the 800 angstrom-thick silicon oxide vapor-deposited film faced the surface of the laminating adhesive layer, followed by dry lamination of the two films.

(4) Separately, another transparent nonstretched polypropylene resin film as prepared in the above step (2) was provided. In the same manner as in the above step (3), a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of this transparent nonstretched polypropylene resin film to a coating thickness of 5.0 g/m² on a dry basis to form a laminating adhesive layer.

Next, the biaxially stretched PET film with an 800 angstrom-thick silicon oxide vapor-deposited film formed thereon subjected to dry lamination for superimposition in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(5) Next, the backside protective sheet for a solar battery module as prepared above was used for the production of a solar battery module. Specifically, a 3 mm-thick glass plate, a 400 μm-thick ethylene-vinyl acetate copolymer sheet, cell strings in which a plurality of crystalline Si-based solar battery elements connected in series through a lead wire, a 400 μm-thick ethylene-vinyl acetate copolymer sheet, and the backside protective sheet for a solar battery module were stacked on top of each other so that the surface of one of the transparent nonstretched polypropylene resin films faced inside, the surface of the solar battery element faced upward and the end face of the laminate was covered with a sealing material of butyl rubber and an aluminum frame, followed by vacuum heating integral molding to produce a solar battery module according to the present invention.

### Example C2

(1) The biaxially stretched PET film and the transparent nonstretched polypropylene resin film as prepared in Example C1 were provided. A styrene-butadiene rubber adhesive into which a crosslinking network of an aromatic isocyanate curing agent containing a benzophenone ultraviolet absorber (2% by weight) as an ultraviolet absorber had been introduced was first gravure roll coated onto one corona-treated surface of the transparent nonstretched polypropylene resin film to a coating thickness of 5.0 g/m² on a dry basis to form a laminating adhesive layer.

Next, the biaxially stretched PET film was put on top of the laminating adhesive layer formed above so that the surface of the silicon oxide vapor-deposited film faced the surface of the laminating adhesive layer, followed by dry lamination of the two films.

(2) Next, in the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the dry laminated biaxially stretched PET film to a coating thickness of 5.0 g/m² on a dry basis to form a laminating adhesive layer.

Next, the biaxially stretched PET film with a silicon oxide vapor-deposited film formed thereon as prepared in Example C1 was put on top of the laminating adhesive layer formed above so that the surface of the silicon oxide vapor-deposited film faced the surface of the laminating adhesive layer, followed by dry lamination of the two films to superimpose the biaxially stretched PET film with an 800 angstrom-thick silicon oxide vapor-deposited film formed thereon.

(3) Separately, another transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, a solar battery module was prepared in the same manner as in Example C1, except that the above backside protective sheet for a solar battery module was used.

### Example C3

(1) Titanium oxide (5% by weight) as a whitening agent, ultrafine particle titanium oxide (particle diameter 0.01 to 0.06 μm, 3% by weight) as an ultraviolet absorber and a benzophenone ultraviolet absorber (1% by weight) also as the ultraviolet absorber, a hindered amine photostabilizer (1% by weight) as a photostabilizer, and other necessary additives were added to a polypropylene resin. The mixture was kneaded thoroughly to prepare a polypropylene resin composition which was then melt extruded through a T die extruder to prepare a 60 μm-thick white colored nonstretched polypropylene resin film. Further, both sides of the white colored nonstretched polypropylene resin film were subjected to corona discharge treatment by a conventional method to form corona-treated surfaces.

(2) A styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the white colored nonstretched polypropylene resin film to a coating thickness of 5.0 g/m² on a dry basis to form a laminating adhesive layer.

Next, the biaxially stretched PET film with a silicon oxide vapor-deposited film formed thereon as used in Example C1 was put on top of the laminating adhesive layer formed above so that the surface of the silicon oxide vapor-deposited film faced the surface of the laminating adhesive layer, followed by dry lamination of the two films.

(3) Separately, the transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film subjected to dry lamination in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, a solar battery module was prepared in the same manner as in Example C1, except that the above backside protective sheet for a solar battery module was used.

### Example C4

(1) The white colored nonstretched polypropylene resin film as used in Example C3 was provided. A styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the white colored nonstretched polypropylene resin film to a coating thickness of 5.0 g/m² on a dry basis to form a laminating adhesive layer.

Next, the biaxially stretched PET film with a silicon oxide vapor-deposited film formed thereon as used in Example C3 was put on top of the laminating adhesive layer formed above so that the surface of the vapor-deposited film faced the surface of the laminating adhesive layer, followed by dry lamination of the two films.

(2) Next, in the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the dry laminated biaxially stretched PET film to a coating thickness of 5.0 g/m² on a dry basis to form a laminating adhesive layer.

Next, another biaxially stretched PET film with a silicon oxide vapor-deposited film formed thereon as prepared in Example C1 was put on top of the laminating adhesive layer formed above so that the surface of the silicon oxide vapor-deposited film faced the surface of the laminating adhesive layer, followed by dry lamination of the two films to superimpose the biaxially stretched PET film with an 800 angstrom-thick silicon oxide vapor-deposited film formed thereon.

(3) Separately, the transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film subjected to dry lamination in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, a solar battery module was prepared in the same manner as in Example C1, except that the above backside protective sheet for a solar battery module was used.

### Example C5

(1) Carbon black (5% by weight), i.e., a blackening agent, as a coloring additive, ultrafine particle titanium oxide (particle diameter 0.01 to 0.06 μm, 3% by weight) as an ultraviolet absorber and a benzophenone ultraviolet absorber (1% by weight) also as the ultraviolet absorber, a hindered amine photostabilizer (1% by weight) as a photostabilizer, and other necessary additives were added to a polypropylene resin. The mixture was kneaded thoroughly to prepare a polypropylene resin composition which was then melt extruded through a T die extruder to prepare a 60 μm-thick black colored nonstretched polypropylene resin film. Further, both sides of the black colored nonstretched polypropylene resin film were subjected to corona discharge treatment by a conventional method to form corona-treated surfaces.

(2) A styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the black colored nonstretched polypropylene resin film to a coating thickness of 5.0 g/m² on a dry basis to form a laminating adhesive layer.

Next, the biaxially stretched PET film with a silicon oxide vapor-deposited film formed thereon as used in Example C1 was put on top of the laminating adhesive layer formed above so that the surface of the silicon oxide vapor-deposited film faced the surface of the laminating adhesive layer, followed by dry lamination of the two films.

(3) Separately, the transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film subjected to dry lamination in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, a solar battery module was prepared in the same manner as in Example C1, except that the above backside protective sheet for a solar battery module was used.

### Example C6

(1) The black colored nonstretched polypropylene resin film as used in Example C5 was provided. A styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the black colored nonstretched polypropylene resin film to a coating thickness of 5.0 g/m² on a dry basis to form a laminating adhesive layer.

Next, the biaxially stretched PET film with a silicon oxide vapor-deposited film formed thereon as used in Example C1 was put on top of the laminating adhesive layer formed above so that the surface of the vapor-deposited film faced the surface of the laminating adhesive layer, followed by dry lamination of the two films.

(2) Next, in the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the dry laminated biaxially stretched PET film to a coating thickness of 5.0 g/m² on a dry basis to form a laminating adhesive layer.

Next, another biaxially stretched PET film with a silicon oxide vapor-deposited film formed thereon as prepared in Example C1 was put on top of the laminating adhesive layer formed above so that the surface of the silicon oxide vapor-deposited film faced the surface of the laminating adhesive layer, followed by dry lamination of the two films to superimpose the biaxially stretched PET film with an 800 angstrom-thick silicon oxide vapor-deposited film formed thereon.

(3) Separately, the transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film subjected to dry lamination in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, a solar battery module was prepared in the same manner as in Example C1, except that the above backside protective sheet for a solar battery module was used.

### Example C7

(1) A 12 μm-thick biaxially stretched polyethylene terephthalate film in which both surfaces thereof had been subjected to corona treatment was provided as a substrate film. The substrate film was mounted on a delivery roll in a plasma chemical vapor deposition apparatus, and an 800 angstrom-thick (80 nm-thick) vapor-deposited film of silicon oxide was formed on one corona-treated surface of the biaxially stretched polyethylene terephthalate film under the following conditions.

(Vapor Deposition Conditions)

Reaction gas mixing ratio: Hexamethyldisiloxane:oxygen gas:helium=1:10:10 (unit:slm)

Degree of vacuum in vacuum chamber: 5.0×10⁻⁶ mbar

Degree of vacuum in vapor deposition chamber: 6.0×10⁻² mbar

Power supplied to cooling electrode drum: 20 kW

Film moving speed: 80 m/min

(2) The white colored nonstretched polypropylene resin film as used in Example C4 was then provided. A two-component curing-type urethane laminating adhesive containing a benzophenone ultraviolet absorber (2.0% by weight) as an ultraviolet absorber was gravure roll coated onto one corona-treated surface of the white colored nonstretched polypropylene resin film to a coating thickness of 5.0 g/m² on a dry basis to form a laminating adhesive layer.

Next, the biaxially stretched polyethylene terephthalate film with an 800 angstrom-thick silicon oxide vapor-deposited film formed thereon as prepared in the above step (1) was put on top of the laminating adhesive layer formed above so that the surface of the 800 angstrom-thick silicon oxide vapor-deposited film faced the surface of the laminating adhesive layer, followed by dry lamination of the two films.

(3) Next, in the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the dry laminated biaxially stretched PET film to a coating thickness of 5.0 g/m² on a dry basis to form a laminating adhesive layer.

Next, another biaxially stretched PET film with a silicon oxide vapor-deposited film formed thereon as prepared in the above step (1) was put on top of the laminating adhesive layer formed thereon so that the surface of the silicon oxide vapor-deposited film in the biaxially stretched PET film faced the surface of the laminating adhesive layer, followed by dry lamination of the two films to superimpose the biaxially stretched PET film with an 800 angstrom-thick silicon oxide vapor-deposited film formed thereon.

(4) Separately, the transparent nonstretched polypropylene resin film as used in Example C1 was provided. In the same manner as described above, a two-component curing-type urethane laminating adhesive containing a benzophenone ultraviolet absorber (2.0% by weight) as an ultraviolet absorber was gravure roll coated onto one corona-treated surface of the transparent nonstretched polypropylene resin film to a coating thickness of 5.0 g/m² on a dry basis to form a laminating adhesive layer.

Next, the biaxially stretched polyethylene terephthalate film with an 800 angstrom-thick silicon oxide vapor-deposited film formed thereon subjected to dry lamination in the above step (3) was put on top of the laminating adhesive layer formed above so that the corona-treated surface of the biaxially stretched polyethylene terephthalate film faced the surface of the laminating adhesive layer, followed by dry lamination of the two films to prepare a backside protective sheet for a solar battery module according to the present invention.

(5) Next, a solar battery module was prepared in the same manner as in Example C1, except that the above backside protective sheet for a solar battery module was used.

### Example C8

(1) A 12 μm-thick biaxially stretched polyethylene terephthalate film in which both surfaces thereof had been subjected to corona treatment was provided as a substrate film. The biaxially stretched polyethylene terephthalate film was first mounted on a delivery roll in a winding-type vacuum vapor deposition apparatus. The biaxially stretched polyethylene terephthalate film was then unwound, and an 800 angstrom-thick (80 nm-thick) vapor-deposited film of silicon oxide was formed on one corona-treated surface of the biaxially stretched polyethylene terephthalate film by electron beam (EB) heating-type vacuum vapor deposition method using silicon monoxide (SiO) as a vapor deposition source while feeding oxygen gas under the following vapor deposition conditions.

(Vapor Deposition Conditions)

Degree of vacuum in vacuum chamber: 1.33×10⁻² Pa (1×10⁻⁴ Torr)

Degree of vacuum in winding chamber: 1.33×10⁻² Pa

Electron beam power: 25 kw

Film moving speed: 400 m/min

Surface for vapor deposition: corona-treated surface

(2) The white colored nonstretched polypropylene resin film as used in Example C4 was then provided. A two-component curing-type urethane laminating adhesive containing a benzophenone ultraviolet absorber (20.0% by weight) as an ultraviolet absorber was gravure roll coated onto one corona-treated surface of the white colored nonstretched polypropylene resin film to a coating thickness of 5.0 g/m² on a dry basis to form a laminating adhesive layer.

Next, another biaxially stretched polyethylene terephthalate film with an 800 angstrom-thick silicon oxide vapor-deposited film formed thereon as prepared in the above step (1) was put on top of the laminating adhesive layer formed above so that the surface of the 800 angstrom-thick silicon oxide vapor-deposited film faced the surface of the laminating adhesive layer, followed by dry lamination of the two films to superimpose the biaxially stretched PET film with an 800 angstrom-thick silicon oxide vapor-deposited film formed thereon.

(3) Separately, another transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film subjected to dry lamination in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, a solar battery module was prepared in the same manner as in Example C1, except that the above backside protective sheet for a solar battery module was used.

### Example C9

(1) The white colored nonstretched polypropylene resin film as used in Example C4 was provided. A two-component curing-type urethane laminating adhesive containing a benzophenone ultraviolet absorber (2.0% by weight) as an ultraviolet absorber was gravure roll coated onto one corona-treated surface of the white colored nonstretched polypropylene resin film to a coating thickness of 5.0 g/m² on a dry basis to form a laminating adhesive layer.

Next, the biaxially stretched polyethylene terephthalate film with an 800 angstrom-thick silicon oxide vapor-deposited film formed thereon as prepared in Example C8 was put on top of the laminating adhesive layer formed above so that the surface of the 800 angstrom-thick silicon oxide vapor-deposited film faced the surface of the laminating adhesive layer, followed by dry lamination of the two films to superimpose the biaxially stretched PET film with an 800 angstrom-thick silicon oxide vapor-deposited film formed thereon.

(2) Next, in the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the dry laminated biaxially stretched PET film to a coating thickness of 5.0 g/m² on a dry basis to form a laminating adhesive layer.

Next, another biaxially stretched PET film with a silicon oxide vapor-deposited film formed thereon as prepared in Example C8 was put on top of the dried laminated biaxailly stretched PET film with the laminating adhesive layer formed thereon so that the surface of the silicon oxide vapor-deposited film in the biaxially stretched PET film faced the surface of the laminating adhesive layer, followed by dry lamination of the two films to superimpose the biaxially stretched PET film with an 800 angstrom-thick silicon oxide vapor-deposited film formed thereon.

(3) Separately, the transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film subjected to dry lamination for superimposition in the above step (2) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(4) Next, a solar battery module was prepared in the same manner as in Example C1, except that the above backside protective sheet for a solar battery module was used.

### Example C10

(1) A blue pigment (a bluing agent) (5% by weight) as a coloring additive and a benzophenone ultraviolet absorber (1% by weight) as an ultraviolet absorber, a hindered amine photostabilizer (1% by weight) as a photostabilizer, and other necessary additives were added to a polypropylene resin. The mixture was kneaded thoroughly to prepare a polypropylene resin composition which was then melt extruded through a T die extruder to prepare an 80 μm-thick blue colored nonstretched polypropylene resin film. Further, both sides of the blue colored nonstretched polypropylene resin film were subjected to corona discharge treatment by a conventional method to form corona-treated surfaces.

(2) The blue colored nonstretched polypropylene resin film was then provided. A two-component curing-type urethane laminating adhesive containing a benzophenone ultraviolet absorber (2.0% by weight) as an ultraviolet absorber was gravure roll coated onto one corona-treated surface of the blue colored nonstretched polypropylene resin film to a coating thickness of 5.0 g/m² on a dry basis to form a laminating adhesive layer.

Next, the biaxially stretched polyethylene terephthalate film with an 800 angstrom-thick silicon oxide vapor-deposited film formed thereon as prepared in Example C1 was put on top of the laminating adhesive layer formed above so that the surface of the 800 angstrom-thick silicon oxide vapor-deposited film faced the surface of the laminating adhesive layer, followed by dry lamination of the two films.

(3) Next, in the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto the corona-treated surface of the dry laminated biaxially stretched PET film to a coating thickness of 5.0 g/m² on a dry basis to form a laminating adhesive layer.

Next, another biaxially stretched PET film with a silicon oxide vapor-deposited film formed thereon as prepared in Example C1 was put on top of the dried laminated biaxailly stretched PET film with the laminating adhesive layer formed thereon so that the surface of the silicon oxide vapor-deposited film in the biaxially stretched PET film faced the surface of the laminating adhesive layer, followed by dry lamination of the two films to superimpose the biaxially stretched PET film with an 800 angstrom-thick silicon oxide vapor-deposited film formed thereon.

(4) Separately, the transparent nonstretched polypropylene resin film as used in Example C1 was provided. In the same manner as described above, a styrene-butadiene rubber adhesive into which a crosslinking network of an aromatic isocyanate curing agent containing a benzophenone ultraviolet absorber (2% by weight) as an ultraviolet absorber had been introduced was gravure roll coated onto one corona-treated surface of the transparent nonstretched polypropylene resin film to a coating thickness of 5.0 g/m² on a dry basis to form a laminating adhesive layer.

Next, the biaxially stretched PET film subjected to dry lamination in the above step (3) was put on top of the laminating adhesive layer formed above so that the corona-treated surface of the biaxially stretched PET film faced the surface of the laminating adhesive layer, followed by dry lamination of the two films to prepare a backside protective sheet for a solar battery module according to the present invention.

(5) Next, a solar battery module was prepared in the same manner as in Example C1, except that the above backside protective sheet for a solar battery module was used.

### Comparative Example 1

A 3 mm-thick glass plate, a 600 μm-thick ethylene-vinyl acetate copolymer sheet, cell strings in which a plurality of crystalline Si-based solar battery elements connected in series through a lead wire, a 400 μm-thick ethylene-vinyl acetate copolymer sheet, and a laminate having a three-layer structure of a 38 μm-thick white polyvinyl fluoride resin film, a 35 μm-thick aluminum foil, and a 38 μm-thick white polyvinyl fluoride resin film were stacked on top of each other so that the surface of the solar battery element faced upward and the end face of the laminate was covered with a sealing material of butyl rubber and an aluminum frame, followed by vacuum heating integral molding to produce a solar battery module.

### Comparative Example 2

A 3 mm-thick glass plate, a 600 μm-thick ethylene-vinyl acetate copolymer sheet, cell strings in which a plurality of crystalline Si-based solar battery elements connected in series through a lead wire, a 400 μm-thick ethylene-vinyl acetate copolymer sheet, and a 5 mm-thick color metallic steel sheet were stacked on top of each other so that the surface of the solar battery element faced upward and the end face of the laminate was covered with a sealing material of butyl rubber and an aluminum frame, followed by vacuum heating integral molding to produce a solar battery module.

The constructions of the backside protective sheets for a solar battery module prepared in the above Examples and Comparative Examples are summarized in Table 1.

TABLE 1
Construction of backside protective sheet for solar battery module

| | Layer construction | Vapor | Dry laminate |
|---|---|---|---|
| | (adhesive layer: | deposition | layer bonding |
| | omitted) | method (*1) | method (*2) |
| Ex. A1 | White PP/deposited | 3 | a |
| | PET/white PP | | |
| Ex. A2 | White PP/deposited | 3 | a |
| | PET/deposited | | |
| | PET/white PP | | |
| Ex. A3 | Black PP/deposited | 3 | a |
| | PET/black PP | | |
| Ex. A4 | Black PP/deposited | 3 | a |
| | PET/deposited | | |
| | PET/black PP | | |
| Ex. B1 | White PP/deposited | 3 | a |
| | PET/black PP | | |
| Ex. B2 | White PP/deposited | 3 | a |
| | PET/black PP | | |
| Ex. B3 | White PP/deposited | 3 | a |
| | PET/deposited | | |
| | PET/black PP | | |
| Ex. B4 | White PP/deposited | 3 | a |
| | PET/deposited | | |
| | PET/black PP | | |
| Ex. B5 | White PP/deposited | 3 | a |
| | PET/PET/deposited | | |
| | PET/black PP | | |
| Ex. B6 | White PP/deposited | 3 | a |
| | PET/deposited | | |
| | PET/black PP | | |
| Ex. C1 | Transparent PP/deposited | 3 | a |
| | PET/transparent PP | | |
| Ex. C2 | Transparent PP/deposited | 3 | a |
| | PET/deposited | | |
| | PET/transparent PP | | |
| Ex. C3 | White PP/deposited | 3 | a |
| | PET/transparent PP | | |
| Ex. C4 | White PP/deposited | 3 | a |
| | PET/deposited | | |
| | PET/transparent PP | | |
| Ex. C5 | Black PP/deposited | 3 | a |
| | PET/transparent PP | | |
| Ex. C6 | Black PP/deposited | 3 | a |
| | PET/deposited | | |
| | PET/transparent PP | | |
| Ex. C7 | White PP/deposited | 1 | a |
| | PET/deposited | | |
| | PET/transparent PP | | |
| Ex. C8 | White PP/deposited | 2 | b |
| | PET/deposited | | |
| | PET/transparent PP | | |
| Ex. C9 | White PP/deposited | 2 | c |
| | PET/deposited | | |
| | PET/transparent PP | | |
| Ex. C10 | Blue PP/deposited | 3 | a |
| | PET/deposited | | |
| | PET/transparent PP | | |
| Comp. Ex. 1 | Colored PVC/aluminum | — | a |
| | foil | | |
| Comp. Ex. 2 | Color metallic steel | — | a |
| | sheet | | |

(*1) 1) Formation of vapor-deposited film by CVD method,
2) formation of vapor-deposited film by EB method,
3) heating by dielectric heating.
(*2) a) Formation of adhesive layer by using a styrene-butadiene rubber adhesive with an aromatic isocyanate curing agent included therein.
b) Formation of adhesive layer by using a two-component curing-type urethane laminating adhesive.
c) Formation of adhesive layer by using an acrylic adhesive with an aromatic isocyanate curing agent included therein.

Evaluation

(1) Water vapor permeability, (2) output lowering rate, (3) tensile strength retention, (4) laminated strength, (5) power generation efficiency, (6) strength of bonding to filler, (7) short-circuit resistance, (8) lightweight properties/flexibility, (9) cost competitiveness, and (10) daylighting properties were measured for the backside protective sheets for a solar battery module prepared in Examples A1 to A4, B1 to B6, and C1 to C10 and the backside protective sheets for a solar battery module prepared in Comparative Examples 1 and 2.

(1) Measurement of Water Vapor Permeability

The water vapor permeabilities of the backside protective sheets for a solar battery module in Examples 1 to 10 according to the present invention and the water vapor permeabilities of the backside protective sheets for a solar battery module prepared in Comparative Examples 1 to 4 were measured with a measuring apparatus (Model: PERMATRAN, manufactured by MOCON, USA) under conditions of temperature 40° C. and humidity 90% RH, and the results were compared and evaluated.

(2) Measurement of Output Lowering Rate

The solar battery modules were subjected to an environmental test according to JIS C 8917-1989. In this case, before and after the test, the photovoltaic output was measured and compared.

(3) Measurement of Tensile Strength Retention

An environmental test was carried out under conditions of temperature 85° C., humidity 85%, and 1000 hr. In this case, before and after the test, the tensile strength was measured, compared and evaluated to determine the tensile strength retention after the test by presuming the tensile strength before the test to be 100%.

For all the samples, the initial tensile strength was not less than 50 N/15 mm width.

In the measurement, the backside protective sheets for a solar battery module in Examples 1 to 10 according to the present invention and the backside protective sheets for a solar battery module prepared in Comparative Examples 1 to 4 were cut into 15 mm width, and the tensile strength was measured with a tensile tester (Model: Tensilon, manufactured by A&D Co., LTD.), and the results were evaluated.

(4) Measurement of Laminated Strength

For the backside protective sheets for a solar battery module prepared in the Examples and Comparative Examples, a 400 μm-thick ethylene-vinyl acetate copolymer sheet as a filler layer was laminated onto one side of each of the backside protective sheets. The laminated sheets were then cut into 15 mm width, and the peel strength of the laminated face of each of the laminated sheets was measured with a tensile tester (Model: Tensilon, manufactured by A&D Co., LTD.) and was evaluated.

(5) Power Generation Efficiency

The power generation efficiency was measured at a module temperature of 25±2° C. by applying a solar simulator as artificial solar light (AM 1.5) according to JIS C 8914.

(6) Strength of Bonding to Filler

For the backside protective sheets for a solar battery module prepared in the Examples and Comparative Examples, a 400 μm-thick ethylene-vinyl acetate copolymer sheet as a filler layer and a glass plate were laminated in that order onto one side of each of the backside protective sheets. The laminates were then slashed (width 15 mm), and the peel strength was measured at a peeling interface of the backside protective sheet for a solar battery module and a filler layer with a tensile tester (Tensilon, manufactured by A&D Co., LTD.), and the strength of bonding to filler was evaluated.

(7) Short-Circuit Resistance

In the same manner as in the measurement of (1) water vapor permeability, the solar battery modules were subjected to an environmental test according to JIS C 8917. Insulating properties were measured according to JIS C 8918, and the results of the measurement of the insulating properties before the test were compared with the results of the measurement of the insulating properties after the test, and the results were evaluated. ◯: Even after the acceleration test, no short-circuiting took place, and the short-circuit resistance was good, and x: short-circuit with the solar battery cell or the aluminum frame part took place due to a deterioration in the substrate film after the acceleration test.

(8) Lightweight Properties

The lightweight properties evaluated by comparing the weight per unit area of the solar battery module. ◯: Weight load to the building structure part at the time of installation of the solar battery module was small, Δ: Some weight load took place, and x: Weight load was large, and, in some cases, the building structure part should be reinforced.

(9) Cost Competitiveness

The costs per unit area of the backside protective sheets for a solar battery module were compared. The cost competitiveness was evaluated: ⊚>◯>Δ>X with ⊚ indicating the highest cost competitiveness and X indicating the lowest cost competitiveness.

⊚: Excellent

◯: Good

Δ: Fair

X: Poor

(10) Daylighting Properties

This evaluation was carried out on the assumption that the solar battery module is installed in a place where daylighting is required, for example, arcades, lighting roofs, wall surface of buildings, and verandas. The permeability of the solar battery module to external light was examined and evaluated: ⊚>◯>Δ>X with ⊚ indicating the highest level of daylighting properties and X indicating the lowest level of daylighting properties.

⊚: Excellent

◯: Good

Δ: Fair

X: Poor

The results of evaluation are shown in Table 2.

TABLE 2
Results of evaluation

| | | Output | Strength of | | | | | |
|---|---|---|---|---|---|---|---|---|
| | Water vapor | lowering | bonding to | Interlaminar | Short-circuit | Lightweight | Cost | |
| | permeability, % S | rate, % | filler, % | strength, % | resistance | properties | competitiveness | Daylighting |
| Ex. | 0.3 | 7 | 63 | 87 | ◯ | ◯ | ⊚ | Δ |
| A1 | | | | | | | | |
| Ex. | 0.1 | 5 | 63 | 89 | ◯ | ◯ | ◯ | Δ |
| A2 | | | | | | | | |
| Ex. | 0.3 | 7 | 61 | 87 | ◯ | ◯ | ⊚ | X |
| A3 | | | | | | | | |
| Ex. | 0.1 | 5 | 61 | 89 | ◯ | ◯ | ◯ | X |
| A4 | | | | | | | | |
| Ex. | 0.3 | 7 | 63 | 87 | ◯ | ◯ | ⊚ | X |
| B1 | | | | | | | | |
| Ex. | 0.3 | 7 | 61 | 87 | ◯ | ◯ | ⊚ | X |
| B2 | | | | | | | | |
| Ex. | 0.1 | 5 | 63 | 89 | ◯ | ◯ | ◯ | X |
| B3 | | | | | | | | |
| Ex. | 0.1 | 5 | 61 | 89 | ◯ | ◯ | ◯ | X |
| B4 | | | | | | | | |
| Ex. | 0.1 | 5 | 62 | 87 | ◯ | ◯ | ◯ | X |
| B5 | | | | | | | | |
| Ex. | 0.1 | 5 | 62 | 89 | ◯ | ◯ | ◯ | X |
| B6 | | | | | | | | |
| Ex. | 0.3 | 7 | 60 | 87 | ◯ | ◯ | ⊚ | ⊚ |
| C1 | | | | | | | | |
| Ex. | 0.1 | 5 | 60 | 89 | ◯ | ◯ | ◯ | ⊚ |
| C2 | | | | | | | | |

In Table 2, the water vapor permeability was expressed in g/m²/day·40° C.·100% RH, the output lowering rate in % (85° C., 85%, 1000 hr), the tensile strength retention in % (85° C., 85%, 1000 hr), and the laminated strength in N/15 mm width.

1. A backside protective sheet for a solar battery module, comprising: a deposited assembly comprising a vapor-deposited film of an inorganic oxide provided on at least one side of a substrate; and a transparent or translucent heat-resistant polyolefin resin layer provided on both sides of said deposited assembly.

2. A backside protective sheet for a solar battery module, comprising: a superimposed laminate comprising a plurality of deposited assemblies superimposed on top of each other, said plurality of deposited assemblies each comprising a vapor-deposited film of an inorganic oxide provided on at least one side of a substrate; and a transparent or translucent heat-resistant polyolefin resin layer provided on both sides of said superimposed laminate.

3. The backside protective sheet for a solar battery module according to claim 2, wherein said superimposed laminate comprises said deposited assemblies superimposed on top of each other through a tough resin layer.

4. The backside protective sheet for a solar battery module according to any one of claims 1 to 3, wherein at least one of the polyolefin resin layers provided respectively on said both sides comprises a coloring additive.

5. The backside protective sheet for a solar battery module according to claim 4, wherein said coloring additive contained in one of the polyolefin resin layer is different from said coloring additive contained in the other polyolefin resin layer in color.

6. A backside protective sheet for a solar battery module, comprising: a deposited assembly comprising a vapor-deposited film of an inorganic oxide provided on at least one side of a substrate; a heat-resistant polyolefin resin layer comprising a coloring additive and provided on one side of said deposited assembly; and a heat sealing resin layer provided on the other side of said deposited assembly.

7. A backside protective sheet for a solar battery module, comprising: a superimposed laminate comprising a plurality of deposited assemblies superimposed on top of each other, said plurality of deposited assemblies each comprising a vapor-deposited film of an inorganic oxide provided on at least one side of a substrate; a heat-resistant polyolefin resin layer comprising a coloring additive and provided on one side of said superimposed laminate; and a heat sealing resin layer provided on the other side of said superimposed laminate.

8. The backside protective sheet for a solar battery module according to claim 7, wherein said superimposed laminate comprises said deposited assemblies superimposed on top of each other through a tough resin layer.

9. The backside protective sheet for a solar battery module according to any one of claims 1 to 8, wherein said heat-resistant polyolefin resin layer comprises an ultraviolet absorber and a photostabilizer.

10. The backside protective sheet for a solar battery module according to any one of claims 1 to 9, wherein a surface-treated layer is provided between said layers.

11. The backside protective sheet for a solar battery module according to claim 10, wherein said surface-treated layer has been formed by pretreatment selected from the group consisting of corona discharge treatment, ozone treatment, plasma treatment, glow discharge treatment, and oxidation treatment using a chemical agent.

12. The backside protective sheet for a solar battery module according to claim 10, wherein said surface-treated layer has been formed using a treatment selected from the group consisting of primer coating agents, undercoating agents, anchor coating agents, adhesives, and vapor deposition anchor coating agents.

13. The backside protective sheet for a solar battery module according to any one of claims 1 to 12, wherein said heat-resistant polyolefin resin layer further comprises an antioxidant.

14. The backside protective sheet for a solar battery module according to claim 13, wherein said antioxidant is selected from the group consisting of phenol, amine, sulfur, and phosphoric acid antioxidants.

15. The backside protective sheet for a solar battery module according to any one of claims 1 to 14, wherein said polyolefin resin layer is provided through an adhesive layer for lamination.

16. The backside protective sheet for a solar battery module according to any one of claims 1 to 14, wherein said polyolefin resin layer is provided through a melt extruded resin layer.

17. The backside protective sheet for a solar battery module according to any one of claims 1 to 16, wherein said substrate is formed of a resin selected from the group consisting of cyclic polyolefin resins, polycarbonate resins, poly(meth)acrylic resins, polystyrene resins, polyamide resins, and polyester resins.

18. The backside protective sheet for a solar battery module according to any one of claims 1 to 17, wherein said vapor-deposited film is a single layer film or multilayer film of two or more layers formed of the same kind of inorganic oxide, or a composite film of two or more layers formed of dissimilar inorganic oxides.

19. The backside protective sheet for a solar battery module according to any one of claims 1 to 18, wherein said vapor-deposited film has a thickness of 50 to 4000 angstroms.

20. The backside protective sheet for a solar battery module according to any one of claims 1 to 19, wherein said vapor-deposited film has been formed by chemical vapor deposition or physical vapor growth.

21. The backside protective sheet for a solar battery module according to any one of claims 1 to 20, wherein said polyolefin resin layer is formed of a polypropylene resin containing a coloring additive, an ultraviolet absorber, and a photostabilizer incorporated by milling.

22. The backside protective sheet for a solar battery module according to any one of claims 1 to 21, wherein said polyolefin resin layer further comprises a flame retardant.

23. The backside protective sheet for a solar battery module according to claim 22, wherein said flame retardant comprises one or at least two compounds selected from the group consisting of phosphorus, phosphorus and halogen, chlorine, bromine, aluminum hydroxide, antimony, magnesium hydroxide, guanidine, zirconium, and zinc borate flame retardants.

24. The backside protective sheet for a solar battery module according to any one of claims 4 to 23, wherein said coloring additive is selected from the group consisting of blackening agents, whitening agents, and bluing agents.

25. The backside protective sheet for a solar battery module according to claim 24, wherein said blackening agent comprises a black pigment.

26. The backside protective sheet for a solar battery module according to claim 24, wherein said whitening agent comprises a white pigment.

27. The backside protective sheet for a solar battery module according to claim 26, wherein said white pigment comprises one or at least two compounds selected from the group consisting of basic lead carbonate, basic lead sulfate, basic lead silicate, zinc flower, zinc sulfide, lithopone, antimony trioxide, anatase form of titanium oxide, and rutile form of titanium oxide.

28. The backside protective sheet for a solar battery module according to claim 24, wherein said bluing agent comprises a blue pigment.

29. The backside protective sheet for a solar battery module according to any one of claims 9 to 28, wherein said ultraviolet absorber comprises at least one inorganic compound selected from the group consisting of benzophenone, benzotriazole, salicylate, acrylonitrile, and metallic complex salt ultraviolet absorbers, ultrafine particle titanium oxide having a particle diameter of 0.01 to 0.06 μm, and ultrafine particle zinc oxide having a particle diameter of 0.01 to 0.04 μm.

30. The backside protective sheet for a solar battery module according to any one of claims 9 to 29, wherein said photostabilizer comprises at least one compound selected from hindered amine compounds.

31. The backside protective sheet for a solar battery module according to any one of claims 21 to 30, wherein said polypropylene resin comprises a resin of a homopolymer of propylene or a copolymer of propylene with other monomer.

32. The backside protective sheet for a solar battery module according to any one of claims 6 to 31, wherein said heat sealing resin layer is formed of a polyolefin resin or an ethylene-vinyl acetate copolymer resin.

33. The backside protective sheet for a solar battery module according to any one of claims 3 to 32, wherein said tough resin layer is formed of a biaxially stretched polyethylene terephthalate film or polypropylene resin film.

34. The backside protective sheet for a solar battery module according to any one of claims 15 and 17 to 33, wherein said adhesive layer for lamination is formed of an adhesive selected from the group consisting of polyvinyl acetate adhesives, polyacrylate adhesives including homopolymers of ethyl acrylate, butyl acrylate or 2-ethylhexylester acrylate, and copolymers of those homopolymers and methyl methacrylate, acrylonitrile or styrene, cyanoacrylate adhesives, ethylene copolymer adhesives including copolymers of ethylene with monomers including vinyl acetate, ethyl acrylate, acrylic acid, methacrylic acid and the like, polyolefin adhesives including polyethylene resins or polypropylene resins, cellulose adhesives, polyester adhesives, polyamide adhesives, polyimide adhesives, amino resin adhesives including urea resins and melamine resins, phenolic resin adhesives, epoxy adhesives, polyurethane adhesives, reactive (meth)acrylic adhesives, rubber adhesives including chloroprene rubbers, nitrile rubbers, styrene-butadiene rubbers, or styrene-isoprene rubbers, silicone adhesives, and inorganic adhesives including alkaline metal silicates or low-melting glass.

35. The backside protective sheet for a solar battery module according to claim 34, wherein said adhesive for lamination causes a heat- or photoenergy-induced reaction in the presence of a curing agent or a crosslinking agent to form a crosslinked structure.

36. The backside protective sheet for a solar battery module according to claim 35, wherein said curing agent or said crosslinking agent comprises an isocyanate compound.

37. The backside protective sheet for a solar battery module according to any one of claims 16 to 33, wherein said melt extruded resin layer is formed of a resin selected from the group consisting of low-density polyethylenes, medium-density polyethylenes, high-density polyethylenes, straight-chain (linear) low-density polyethylenes, polypropylenes, ethylene-vinyl acetate copolymers, ionomer resins, ethylene-ethyl acrylate copolymers, ethylene-acrylic acid copolymers, ethylene-methacrylic acid copolymers, ethylene-propylene copolymers, and methyl pentene polymers, and acid-modified polyolefin resins produced by modifying polyolefin resins, such as polyethylene resins or polypropylene resins, by an unsaturated carboxylic acid, such as acrylic acid, methacrylic acid, maleic anhydride, fumaric acid, or itaconic acid.

38. A module for a solar battery, comprising the backside protective sheet for a solar battery module according to any one of claims 1 to 37, said module having been produced through integral molding by a pressure contact bonding lamination process comprising stacking said protective sheet, a filler layer, a solar battery element, a filler layer, and said protective sheet on top of one another in that order so that said polyolefin resin layer or said heat sealing resin layer provided on one side of said protective sheet faces said filler layer, and subjecting the resultant laminate to vacuum suction.
